(19) United States
(12) Patent Application Publication
(10) Pub. No.: US 2024/0169552 A1
(43) Pub. Date: May 23, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Shohei YAMAUCHI, Kanagawa (JP)

(21) Appl. No.: 18/500,185

(22) Filed: Nov. 2, 2023

(30) Foreign Application Priority Data
Nov. 18, 2022 (JP) 2022-184759

(51) Int. Cl. G06T 7/194; G06T 15/20

(52) U.S. Cl. CPC G06T 7/194; G06T 15/205

(57) ABSTRACT

The image processing apparatus generating three-dimensional shape data corresponding to a foreground object for which synchronous image capturing is performed by a plurality of imaging apparatuses according to the present disclosure identifies an unnecessary space, which is a space unnecessary in a case where three-dimensional shape data is generated, from a first generation space in a virtual space corresponding to an image capturing-target space, generates information indicating a second generation space after the unnecessary space is deleted by deleting the identified unnecessary space from the first generation space, and generates the three-dimensional shape data corresponding to the foreground object in the second generation space based on image capturing parameters of an imaging apparatus, which is at least part of the plurality of imaging apparatuses, a captured image obtained by image capturing by the part of the imaging apparatuses, and information indicating the second generation space.

### FIELD

The present disclosure relates to a generation technique of three-dimensional shape data.

### DESCRIPTION OF THE RELATED ART

There is a technique to generate a virtual viewpoint image corresponding to an image in a case where an object is viewed from an arbitrary virtual viewpoint by using a plurality of captured images (in the following, called “multi-viewpoint image”) obtained by image capturing by installing a plurality of imaging apparatuses at different positions and performing synchronous image capturing from a plurality of viewpoints. In this technique, first, by using the background difference method, the machine learning method or the like, a foreground silhouette image indicating the image area in a captured image is generated, which corresponds to an object captured in the captured image. Following the above, by using the foreground silhouette image corresponding to each captured image configuring a multi-viewpoint image, three-dimensional shape data corresponding to the object is generated. Following the above, by appropriately pasting an arbitrary captured image configuring the multi-viewpoint image to the generated three-dimensional shape data, it is possible to generate a virtual viewpoint image. “The visual hull concept for silhouette-based image understanding” (Authors: A. Laurentini, Date of Publication: February 1994) (in the following, called “Non-Patent Document 1”) has disclosed the visual hull method, which is a technique for generating three-dimensional shape data from a foreground silhouette image. In the general visual hull method disclosed in Non-Patent Document 1, the three-dimensional space in which three-dimensional shape data is generated (in the following, called “generation space”) is defined by a simple space that can be defined by several straight lines, such as a rectangular parallelepiped or a tetrahedron.

In a case where the generation space is defined by such a simple space, it may happen that the generation space includes a space that is not necessary for generating three-dimensional shape data (in the following, called “unnecessary space”). In a case where the unnecessary space is included in the generation space, the visual hull method is also applied to the unnecessary space, and therefore, there is such a problem that the amount of calculation increases in a case where three-dimensional shape data is generated.

### SUMMARY

The image processing apparatus according to the present disclosure is an image processing apparatus that generates three-dimensional shape data corresponding to a foreground object for which synchronous image capturing is performed by a plurality of imaging apparatuses, and includes: one or more hardware processors; and one or more memories storing one or more programs configured to be executed by the one or more hardware processors, the one or more programs including instructions for: identifying an unnecessary space, which is a space unnecessary in a case where three-dimensional shape data is generated, from a first generation space in a virtual space corresponding to an image capturing-target space; generating information indicating a second generation space after the unnecessary space is deleted by deleting the identified unnecessary space from the first generation space; and generating the three-dimensional shape data corresponding to the foreground object in the second generation space based on image capturing parameters of an imaging apparatus, which is at least part of the plurality of imaging apparatuses, a captured image obtained by image capturing by the part of the imaging apparatuses, and information indicating the second generation space.

Further features of the present invention will become apparent from the following description of exemplary embodiments with reference to the attached drawings.

### BRIEF DESCRIPTION OF THE DRAWINGS

FIG. 1 is a diagram for explaining one example of a configuration of an image processing system according to Embodiment 1;

FIG. 2 is a block diagram showing one example of a function configuration of a first image processing apparatus and a second image processing apparatus according to Embodiment 1;

FIG. 3 is a block diagram showing one example of a hardware configuration of the first image processing apparatus and the second image processing apparatus according to Embodiment 1;

FIG. 4 is a flowchart showing one example of a processing flow of the first image processing apparatus according to Embodiment 1;

FIG. 5 is a flowchart showing one example of a processing flow of the second image processing apparatus according to Embodiment 1;

FIG. 6A is a diagram showing one example of an installation position of an imaging apparatus according to Embodiment 1, FIG. 6B is a diagram showing one example of an unnecessary area mask image, FIG. 6C is a diagram showing one example of a voxel group in a generation space, and FIG. 6D is a diagram showing one example of the way voxels in an unnecessary space are deleted from the voxel group in the generation space;

FIG. 7 is a block diagram showing one example of a function configuration of a first image processing apparatus and a second image processing apparatus according to Embodiment 2;

FIG. 8 is a flowchart showing one example of a processing flow of the first image processing apparatus according to Embodiment 2;

FIG. 9A is a diagram showing one example of a temporary foreground silhouette image according to Embodiment 2, FIG. 9B is a diagram showing one example of a captured image mask image, and FIG. 9C is a diagram showing one example of a foreground silhouette image;

FIG. 10 is a block diagram showing one example of a function configuration of a first image processing apparatus and a second image processing apparatus according to Embodiment 3;

FIG. 11 is a flowchart showing one example of a processing flow of the second image processing apparatus according to Embodiment 3;

FIG. 12A is a diagram showing one example of a captured image according to Embodiment 3, FIG. 12B is a diagram showing one example of a temporary foreground silhouette image, FIG. 12C is a diagram showing one example of an unnecessary area mask image, FIG. 12D is a diagram showing one example of a foreground silhouette image, FIG. 12E is a diagram showing one example of a voxel group in a generation space, and FIG. 12F is a diagram showing one example of the way voxels in an unnecessary space are deleted from the voxel group in the generation space;

FIG. 13 is a diagram for explaining one example of a configuration of an image processing system according to Embodiment 4;

FIG. 14 is a block diagram showing one example of a function configuration of a first image processing apparatus and a second image processing apparatus according to Embodiment 4;

FIG. 15 is a flowchart showing one example of a processing flow of the second image processing apparatus according to Embodiment 4;

FIG. 16 is a diagram for explaining one example of a configuration of an image processing system according to Embodiment 5;

FIG. 17 is a block diagram showing one example of a function configuration of a first image processing apparatus and a second image processing apparatus according to Embodiment 5;

FIG. 18 is a flowchart showing one example of a processing flow of the second image processing apparatus according to Embodiment 5; and

FIG. 19A is a diagram showing one example of a distance from a position of an imaging apparatus according Embodiment 5 to a point on a boundary surface between an actually existing space corresponding to a generation space after deletion and an actually existing space corresponding to an unnecessary space, FIG. 19B is a diagram showing one example of an unnecessary area mask image, and FIG. 19C is a diagram showing one example of a depth map.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### Embodiment 1

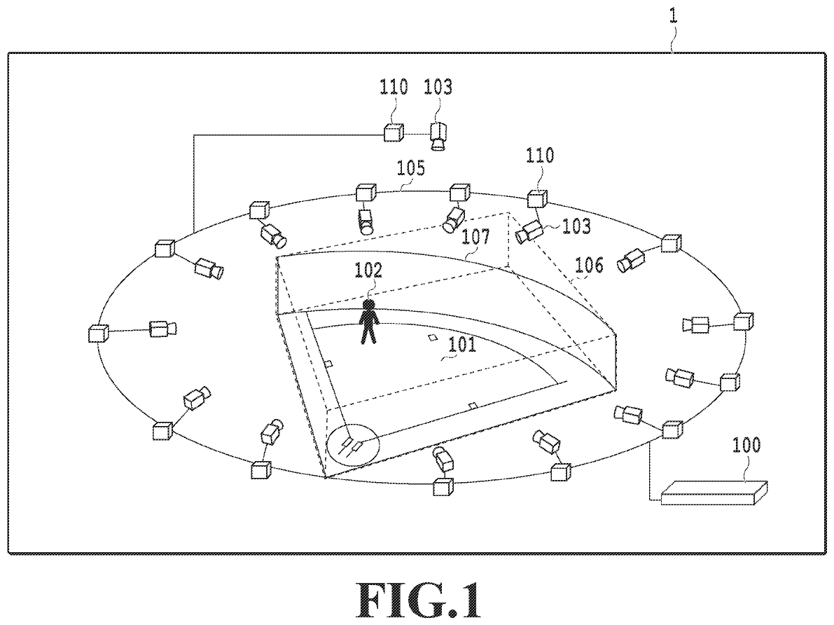

With reference to FIG. 1 to FIG. 6D, an image processing system 1 according to Embodiment 1 is explained. In Embodiment 1, an aspect is explained in which three-dimensional shape data is generated after deleting a spatial area corresponding to an unnecessary space from a generation space including the unnecessary space in generation processing of three-dimensional shape data corresponding to an actually existing object using the visual hull method. In the following, explanation is given by describing the spatial area corresponding to the unnecessary space as “unnecessary spatial area” and the generation space after the unnecessary spatial area is deleted as “generation space after deletion”.

### System Configuration

FIG. 1 is a diagram for explaining one example of the configuration of the image processing system 1 according to Embodiment 1. It is assumed that on a field 101 of a sports stadium, a game such as baseball is played and on the field 101, as an object taken to be a foreground (in the following, called “foreground object”), a person 102 exists. The foreground object includes a player, a manager, or a person such as a referee, or a ball and the like. Further, the foreground object may be a moving object or a stationary object. Around the field 101, a plurality of imaging apparatuses 103 is arranged so to be capable of capturing an actually existing space 106 entirely, which corresponds to a generation space in a virtual space. Each imaging apparatus 103 performs synchronous image capturing from a plurality viewpoints for a game or the like played on the field 101. A space 107 is a partial space of the space 106 and represents an actually existing space corresponding to the generation space after deletion in the virtual space, which is used in a case where three-dimensional shape data is generated. The image processing system 1 comprises a plurality of first image processing apparatuses 110, each of which is an image processing apparatus corresponding to each imaging apparatus 103 and which processes captured images obtained by image capturing by each imaging apparatus 103.

Each imaging apparatus 103 and the first image processing apparatus 110 corresponding to the imaging apparatus 103 are connected so as to be capable of communication with each other by an SDI cable or the like. Each first image processing apparatus 110 receives an image signal that is output by the imaging apparatus 103 connected by an SDI cable or the like and obtains data of the captured image (in the following, called “captured image data”) corresponding to the image signal. Each first image processing apparatus 110 identifies the image area corresponding to the foreground object in the captured image, generates a foreground silhouette image indicating the image area, and outputs data of the foreground silhouette image (in the following, called “foreground silhouette image data”). Further, the first image processing apparatus 110 also outputs captured image data used in a case where the foreground silhouette image data is generated, or data of the foreground texture obtained by extracting the image area corresponding to the foreground area in the foreground silhouette image from the captured image. In the following, the foreground silhouette image data and the captured image data used in a case where the foreground silhouette image data is generated, or the foreground texture data extracted from the captured image are called together foreground data.

The adjacent first image processing apparatuses 110 are connected to each other by a network cable 105 and all the first image processing apparatuses 110 are connected by, for example, the ring-type network connection. The two adjacent first image processing apparatuses 110 are configured so that one of the two adjacent first image processing apparatuses 110 sequentially transfers foreground data to the other first image processing apparatus 110. That is, the three consecutive first image processing apparatuses 110 are configured so that the middle first image processing apparatus 110 combines the foreground data obtained from the previous first image processing apparatus 110 with the foreground data output by the middle first image processing apparatus 110 itself and transfers the combined data to the next first image processing apparatus 110 connected via the network cable 105.

The foreground data that is output by each first image processing apparatus 110 is ultimately transferred to a second image processing apparatus 100. The second image processing apparatus 100 generates three-dimensional shape data corresponding to the object by the visual hull method using the foreground silhouette image included in the received foreground data. Further, the second image processing apparatus 100 generates a virtual viewpoint image corresponding to the image in a case where the object is viewed from an arbitrary virtual viewpoint by using the generated three-dimensional shape data and the captured image or the foreground texture included in the received foreground data. The aspect of the network connection shown in FIG. 1 is merely one example and the aspect is not limited to the ring-type network connection and the connection aspect may be another connection aspect, such as the star-type network connection.

### Configuration of First Image Processing Apparatus and Second Image Processing Apparatus

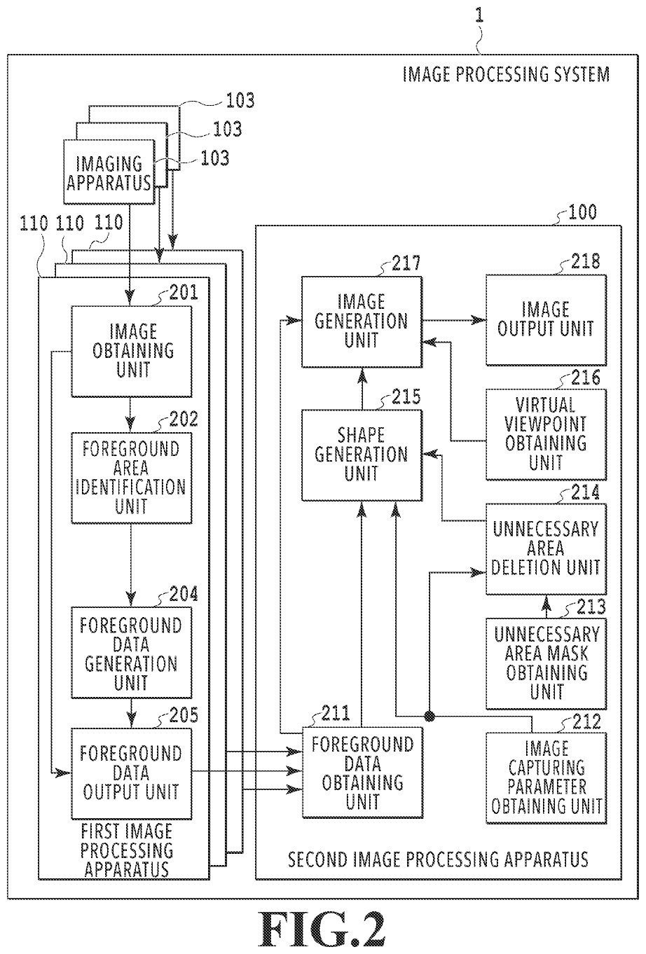

With reference to FIG. 2, the function configuration of the first image processing apparatus 110 and the second image processing apparatus 100 is explained. FIG. 2 is a block diagram showing one example of the function configuration of the first image processing apparatus 110 and the second image processing apparatus 100 according to Embodiment 1. The first image processing apparatus 110 comprises an image obtaining unit 201, a foreground area identification unit 202, a foreground data generation unit 204, and a foreground data output unit 205. The second image processing apparatus 100 comprises a foreground data obtaining unit 211, an image capturing parameter obtaining unit 212, an unnecessary area mask obtaining unit 213, an unnecessary area deletion unit 214, a shape generation unit 215, a virtual viewpoint obtaining unit 216, an image generation unit 217, and an image output unit 218. The processing of each unit comprised by the first image processing apparatus 110 and the second image processing apparatus 100 as the function component is performed by hardware, such as an ASIC (Application Specific Integrated Circuit), which is incorporated in the first image processing apparatus 110 or the second image processing apparatus 100. The processing may be performed by hardware, such as an FPGA (Field Programmable Gate Array). Further, the processing may be performed by software using a processor, such as CPU (Central Processing Unit) or GPU (Graphic Processor Unit), and a memory, such as RAM (Random Access Memory).

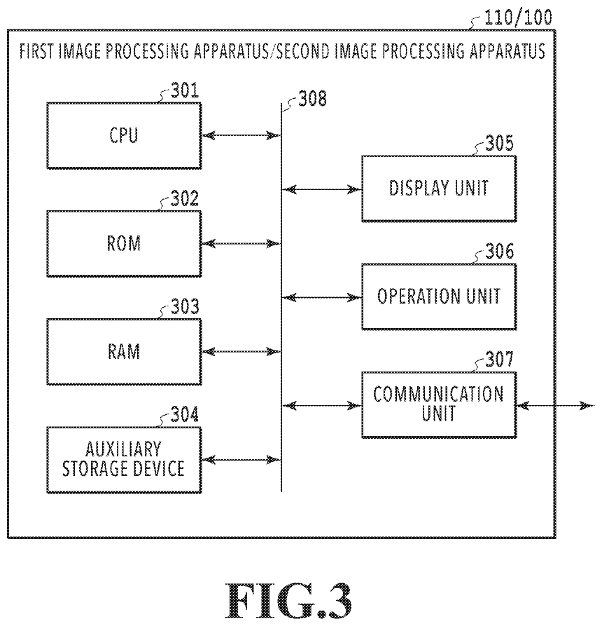

FIG. 3 is a block diagram showing one example of the hardware configuration of the first image processing apparatus 110 and the second image processing apparatus 100 in a case where each unit comprised by the first image processing apparatus 110 and the second image processing apparatus 100 according to Embodiment 1 as the function component operates by software. Each of the first image processing apparatus 110 and the second image processing apparatus 100 has a CPU 301, a ROM 302, a RAM 303, an auxiliary storage device 304, a display unit 305, an operation unit 306, a communication unit 307, and a bus 308.

The CPU 301 causes a computer to function as each unit comprised by the first image processing apparatus 110 and the second image processing apparatus 100 as the function configuration by controlling the computer by using programs or data stored in the ROM 302 or the RAM 303. It may also be possible for the first image processing apparatus 110 or the second image processing apparatus 100 to have one or a plurality of pieces of dedicated hardware different from the CPU 301 and the dedicated hardware may perform at least part of the processing that is performed by the CPU 301. As an example of the dedicated hardware, there are an ASIC, an FPGA, a DSP (Digital Signal Processor) and the like. The ROM 302 stores programs and the like that do not need to be changed. The RAM 303 temporarily stores programs or data supplied from the auxiliary storage device 304, or data or the like supplied from the outside via the communication unit 307. The auxiliary storage device 304 includes, for example, a hard disk drive or the like, and stores various types of data, such as image data or voice data.

The display unit 305 includes, for example, a liquid crystal display, an LED or the like and displays a GUI (Graphical User Interface) or the like for a user to operate or browse the first image processing apparatus 110 or the second image processing apparatus 100. The operation unit 306 includes, for example, a keyboard, mouse, joystick, touch panel or the like and inputs various instructions to the CPU 301 upon receipt of the operation by a user. The CPU 301 also operates as a display control unit configured to control the display unit 305 and an operation control unit configured to control the operation unit 306.

The communication unit 307 is used for communication with an external device of each of the first image processing apparatus 110 and the second image processing apparatus 100. For example, in a case where the first image processing apparatus 110 or the second image processing apparatus 100 is connected with an external device by a wire, a communication cable is connected to the communication unit 307. In a case where the first image processing apparatus 110 or the second image processing apparatus 100 has a function to wirelessly communicate with an external device, the communication unit 307 comprises an antenna. The bus 308 connects each unit comprised by each of the first image processing apparatus 110 and the second image processing apparatus 100 and transmits information. In Embodiment 1, explanation is given on the assumption that the display unit 305 and the operation unit 306 exist inside each of the first image processing apparatus 110 and the second image processing apparatus 100. At least one of the display unit 305 and the operation unit 306 may exist as another device outside each of the first image processing apparatus 110 and the second image processing apparatus 100.

### Processing of First Image Processing Apparatus and Second Image Processing Apparatus

The processing of each unit comprised by each of the first image processing apparatus 110 and the second image processing apparatus 100 as the function component is explained. First, the processing of each unit comprised by the first image processing apparatus 110 as the function component is explained. The image obtaining unit 201 receives the image signal that is output by the imaging apparatus 103 via an SDI cable or the like and obtains the data of the image indicated by the image signal as the captured image data. The source from which the image obtaining unit 201 obtains captured image data is not limited to the imaging apparatus 103. For example, it may also be possible for the image obtaining unit 201 to obtain captured image data by reading the captured image data from a storage device, not shown schematically in FIG. 1, which stores the captured image data in advance, in place of obtaining captured image data from the imaging apparatus 103.

The foreground area identification unit 202 separates the foreground area from the background area by identifying the image area corresponding to the foreground object (in the following, called “foreground area”) in the captured image obtained by the image obtaining unit 201 by the foreground/background separation method by the commonly known background difference method or the like. It may also be possible to generate the data of the background image that is used in a case where the foreground is separated from the background from the captured image obtained by the image obtaining unit 201, or the data may be set in advance by a user or the like. As the method of generating a background image, it may be possible to use the commonly known technique. For example, the foreground area identification unit 202 identifies the image area in which the pixel value does not change in each captured image as the background area based on a plurality of captured images whose image capturing times are different from one another, and generates a background image based on the captured image and the identified background area. The foreground/background separation method by the background difference method or the like is commonly known, and therefore, explanation thereof is omitted. The foreground area identification method is not limited to the foreground/background separation method by the background difference processing and for the foreground area identification, it may also be possible to use the foreground area estimation method using a trained model obtained by machine learning, or an arbitrary method, such as the foreground area extraction method, by the chroma key processing or the like.

The foreground data generation unit 204 generates a foreground silhouette image based on the foreground area identified by the foreground area identification unit 202 and takes the generated foreground silhouette image data as the foreground data. The foreground silhouette image is an image (in the following, called “binary image”) representing the foreground area and the background area by two values by, for example, setting the value of the pixel included in the foreground area to “1” and the value of the pixel included in the background area to “0” in the captured image. The foreground silhouette image may be an image whose resolution is the same as that of the captured image, or may be one or more images obtained by cutting out the image area corresponding to each of one or more foreground images independent of one another in the captured image by using a circumscribed rectangle or the like. Further, in the foreground silhouette image according to Embodiment 1, the image area configured by the pixels whose pixel value is “1” indicates the foreground area and the image area configured by the pixels whose pixel value is “0” indicates the background area, but the foreground silhouette image is not limited to this. For example, it may also be possible for the foreground data generation unit 204 to generate a foreground silhouette image so that the image area configured by the pixels whose pixel value is “0” indicates the foreground area and the image area configured by the pixels whose pixel value is “1” indicates the background area.

It may also be possible for the foreground data generation unit 204 to generate the data of the foreground texture (in the following, called “foreground texture data”) by extracting the image area corresponding to the foreground area in the foreground silhouette image from the captured image. The foreground data output unit 205 outputs the foreground silhouette image data as the foreground data. Specifically, the foreground data output unit 205 outputs the foreground data by including the captured image data that is used in a case where the foreground silhouette image is generated or the foreground texture data that is generated by the foreground data generation unit 204 in the foreground data, in addition to the foreground silhouette image data.

Next, the processing of each unit comprised by the second image processing apparatus 100 as the function configuration is explained. The foreground data obtaining unit 211 obtains the foreground data each of the plurality of the first image processing apparatuses 110 outputs. The image capturing parameter obtaining unit 212 obtains image capturing parameters of each imaging apparatus 103, which are set in advance via the operation unit 306 or the like. Specifically, for example, the image capturing parameter obtaining unit 212 obtains image capturing parameters by reading the image capturing parameters stored in advance in the auxiliary storage device 304. The image capturing parameters include external parameters indicating the position, the direction of the optical axis or the like of the imaging apparatus 103, internal parameters indicating the viewing angle or focal length of the imaging apparatus 103, or the position of the center pixel of the captured image or the like, distortion parameters indicating the distortion of the optical system of the imaging apparatus 103, and the like. It is assumed that the position of the imaging apparatus 103 and the direction of the optical axis of the imaging apparatus 103 are represented by a position vector in the world coordinate system, or a position vector and a rotation matrix. The method of representing the position of the imaging apparatus 103 and the direction of the optical axis of the imaging apparatus 103 is not limited to that described above.

For example, it is possible to calculate the image capturing parameters by processing as follows. First, a marker image for calibrating the imaging apparatus, such as a checkerboard, is captured by each imaging apparatus 103. Following the above, the point (in the following, called “corresponding point”) corresponding to the feature point on the marker image in the captured image obtained by image capturing is identified. Following the above, in the captured image obtained by image capturing by each imaging apparatus 103, a corresponding point corresponding to the same feature point on the marker image is associated. Following the above, image capturing parameters are calculated by calibrating each imaging apparatus while performing optimization so that the distance between the position of the feature point in each captured image in a case where the feature point is projected toward each imaging apparatus and the corresponding point is the minimum. The calibration method of the imaging apparatus is not limited to the above-described method and it is possible to use a commonly known method.

The unnecessary area mask obtaining unit 213 obtains the data of the mask image for masking the image area in which the actually existing space corresponding to the unnecessary spatial area is captured in the captured images obtained by image capturing by the one or more imaging apparatuses 103 of the plurality of the imaging apparatuses 103. In the following, the data of the mask image that is obtained by the unnecessary area mask obtaining unit 213 is called the data of the unnecessary area mask image (in the following, called “unnecessary area mask image data”). Here, the actually existing space corresponding to the unnecessary spatial area is, for example, the space 106 shown in FIG. 1 from which the space 107 is removed. It is possible for a user to prepare in advance the unnecessary area mask image data corresponding to each imaging apparatus 103 by supposing in advance the image capturing parameters, such as the position, the direction of the optical axis, and the viewing angle, of each imaging apparatus 103 and the position of the space 107. In the following, an imaging apparatus group including one or more of the imaging apparatuses 103 described above, which correspond to the captured images that are masked by using the unnecessary area mask image data, among the plurality of the imaging apparatuses 103 is called a first imaging apparatus group. Further, an imaging apparatus group including the plurality of the imaging apparatuses 103 from which the imaging apparatuses 103 belonging to the first imaging apparatus group are removed is called a second imaging apparatus group. That is, the unnecessary area mask obtaining unit 213 obtains the unnecessary area mask image data corresponding to each imaging apparatus 103 belonging to the first imaging apparatus group.

The unnecessary area deletion unit 214 deletes the unnecessary space from the simple generation space prepared in advance, which includes the unnecessary space and can be defined by a rectangular parallelepiped, a tetrahedron or the like, by using the unnecessary area mask image data that is obtained by the unnecessary area mask obtaining unit 213. Specifically, first, the unnecessary area deletion unit 214 identifies the area corresponding to the unnecessary space in the generation space by using the unnecessary area mask image data and the image capturing parameters of the imaging apparatus 103, which correspond to the unnecessary area mask image data. Following the above, the unnecessary area deletion unit 214 generates the generation space after deletion, which is the generation space after the unnecessary space is deleted by deleting the identified area from the generation space.

The shape generation unit 215 generates three-dimensional shape data corresponding to the foreground object by the visual hull method. Specifically, the shape generation unit 215 generates three-dimensional shape data in the generation space after deletion by using the foreground silhouette image data included in the foreground data that is output by the imaging apparatus 103 belonging to the second imaging apparatus group and the image capturing parameters of the imaging apparatus 103. The three-dimensional shape data that is generated by the shape generation unit 215 is represented by polygon data, voxel data or the like. In the following, explanation is given on the assumption that the three-dimensional shape data that is generated by the shape generation unit 215 is represented by voxel data. In this case, the generation space and the generation space after deletion are represented by voxel data. That is, the unnecessary area deletion unit 214 deletes the voxels corresponding to the unnecessary spatial area from the voxel group in the generation space prepared in advance by using the unnecessary area mask image data corresponding to the imaging apparatus 103 belonging to the first imaging apparatus group and the image capturing parameters. The deletion of voxel referred to here includes the change from the ON voxel to the OFF voxel. The specific voxel deletion method in the unnecessary area deletion unit 214 will be described later.

The voxel data of the generation space after deletion is the data of the voxel group after the voxels corresponding to the unnecessary space are deleted from the voxel group in the generation space. Because of this, in a case where three-dimensional shape data is generated in the generation space after deletion, it is possible to reduce the amount of calculation in a case where three-dimensional shape data is generated compared to a case where three-dimensional shape data is generated in the generation space. In the above, explanation is given on the assumption that the shape generation unit 215 uses the foreground silhouette image data included in the foreground data that is output from the imaging apparatus 103 belonging to the second imaging apparatus group and the image capturing parameters of the imaging apparatus 103, but this is not limited. For example, the shape generation unit 215 may also use the foreground silhouette image data included in the foreground data that is output from the imaging apparatus 103 belonging to the first imaging apparatus group and the image capturing parameters of the imaging apparatus 103 in a case where three-dimensional shape data is generated.

The virtual viewpoint obtaining unit 216 obtains information (in the following, called “virtual viewpoint information”) indicating the position of the virtual viewpoint and the direction of the line-of-sight from the virtual viewpoint. The virtual viewpoint information is set via the operation unit 306 or the like. The image generation unit 217 generates a virtual viewpoint image by using the virtual viewpoint information that is obtained by the virtual viewpoint obtaining unit 216, the three-dimensional shape data that is generated by the shape generation unit 215, and the captured image data or the data of the foreground texture included in the foreground data that is obtained by the foreground data obtaining unit 211. The method of generating a virtual viewpoint image is commonly known, and therefore, explanation thereof is omitted. The image output unit 218 outputs the data or signal of the virtual viewpoint image to the auxiliary storage device 304, the display unit 305 or the like.

### Operation of First Image Processing Apparatus and Second Image Processing Apparatus

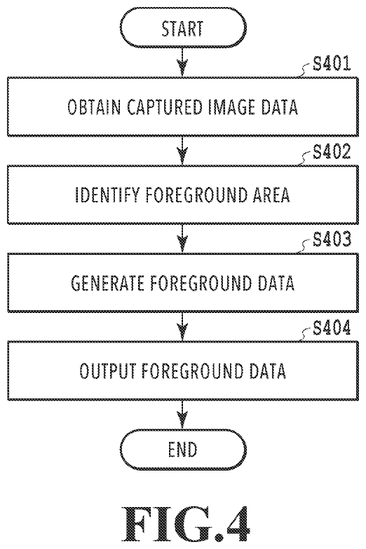

The operation of the first image processing apparatus 110 and the second image processing apparatus 100 is explained. First, with reference to FIG. 4, the operation of the first image processing apparatus 110 is explained. FIG. 4 is a flowchart showing one example of a processing flow of the first image processing apparatus 110 according to Embodiment 1. The first image processing apparatus 110 repeatedly performs the processing of the flowchart while the second image processing apparatus 100 continues to generate a virtual viewpoint image. In the following explanation, a symbol “S” means a step.

First, at S401, the image obtaining unit 201 obtains captured image data. Next, at S402, the foreground area identification unit 202 identifies the image area (foreground area) corresponding to the foreground object in the captured image by using the captured image data obtained at S401. Next, at S403, the foreground data generation unit 204 generates foreground data including the foreground silhouette image data based on the foreground area identified at S402. It is assumed that the foreground data includes the captured image data used in a case where the foreground silhouette image data is generated or the data of the foreground texture corresponding to the captured image data, in addition to the foreground silhouette image data. Next, at S404, the foreground data output unit 205 outputs the foreground data generated at S403. After S404, the first image processing apparatus 110 terminates the processing of the flowchart shown in FIG. 4 and after the termination, the first image processing apparatus 110 returns to S401 and repeatedly performs the processing of the flowchart while the second image processing apparatus 100 continues to generate a virtual viewpoint image. For example, in a case where the imaging apparatus 103 captures a moving image, the first image processing apparatus 110 performs the processing of the flowchart shown in FIG. 4 for each frame in the moving image.

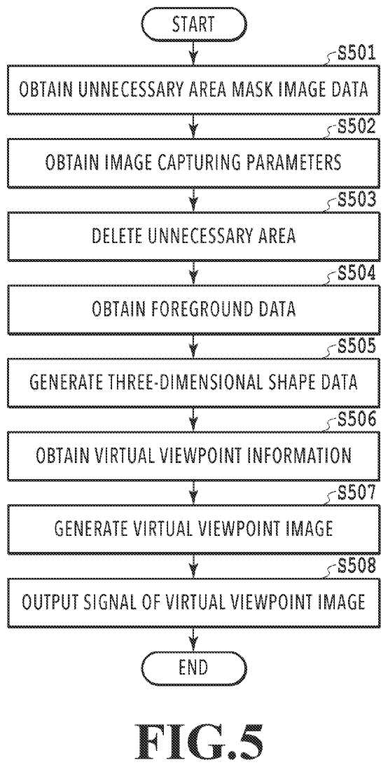

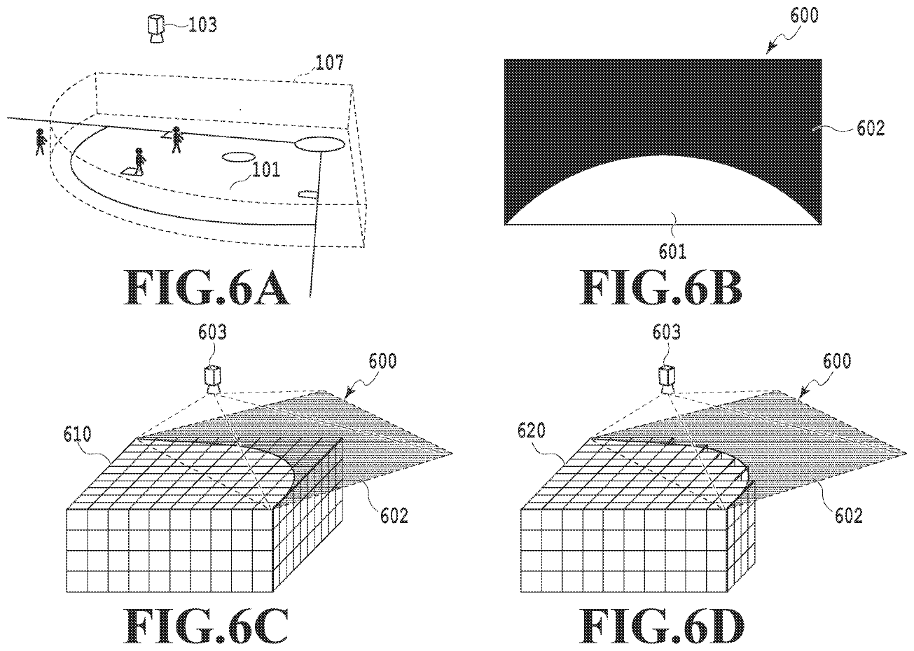

With reference to FIG. 5 and FIG. 6A to FIG. 6D, the operation of the second image processing apparatus 100 is explained. FIG. 5 is a flowchart showing one example of a processing flow of the second image processing apparatus 100 according to Embodiment 1. The second image processing apparatus 100 repeatedly performs the processing of the flowchart until, for example, instructions to terminate the generation of a virtual viewpoint image are input from the operation unit 306. First, at S501, the unnecessary area mask obtaining unit 213 obtains unnecessary area mask image data.

FIG. 6A is a diagram showing one example of the installation position of the imaging apparatus 103 belonging to the first imaging apparatus group. The imaging apparatus 103 belonging to the first imaging apparatus group is installed, for example, at the position from which the field 101 is captured from directly above as shown as one example in FIG. 6A. FIG. 6B is a diagram showing one example of an unnecessary area mask image 600 for masking the image area in which the actually existing space corresponding to the unnecessary spatial area is captured in the captured image obtained by image capturing by the imaging apparatus 103 belonging to the first imaging apparatus group shown in FIG. 6A. In the unnecessary area mask image 600, an area 601 is the area corresponding to the image area in which the actually existing space corresponding to the generation space after deletion is captured in the captured image and the area that does not mask the captured image. Further, an area 602 is the area corresponding to the image area in which the actually existing space corresponding to the unnecessary spatial area is captured in the captured image and the area that masks the captured image (in the following, called “mask area”). The unnecessary area mask obtaining unit 213 obtains, for example, the data of the unnecessary area mask image 600 shown in FIG. 6B, which corresponds to the imaging apparatus 103 belonging to the first imaging apparatus group shown in FIG. 6A.

After S501, at S502, the image capturing parameter obtaining unit 212 obtains the image capturing parameters of the imaging apparatus 103 belonging to the first imaging apparatus group and the image capturing parameters of the imaging apparatus 103 belonging to the second imaging apparatus group. For example, it is assumed that to each imaging apparatus 103, the identifier for identifying the imaging apparatus 103 is assigned in advance and the imaging apparatus 103 belonging to the first imaging apparatus group and the imaging apparatus 103 belonging to the second imaging apparatus group are managed by using the identifier. Further, for example, it is assumed that the image capturing parameters include information indicating the identifier and it is possible associate the imaging apparatus 103 with the first imaging apparatus group or the second imaging apparatus group by the identifier. After S502, at S503, the unnecessary area deletion unit 214 deletes the voxels in the unnecessary space from the voxel group in the generation space by using the unnecessary area mask image data obtained at S501 and the image capturing parameters obtained at S502. Specifically, the unnecessary area deletion unit 214 first, identifies the area corresponding to the unnecessary space in the generation space by using the unnecessary area mask image data and the image capturing parameters. Following the above, the unnecessary area deletion unit 214 deletes the voxels corresponding to the identified area from the voxel group in the generation space.

With reference to FIG. 6C and FIG. 6D, the method of deleting the voxels in the unnecessary space from the voxel group in the generation space is explained. FIG. 6C is a diagram showing one example of the way a virtual imaging apparatus 603 in the virtual space, which corresponds to the imaging apparatus 103 belonging to the first imaging apparatus group, captures a voxel group 610 in the generation space corresponding to the space 106. FIG. 6D is a diagram showing one example of the way the unnecessary area deletion unit 214 according to Embodiment 1 deletes the voxels in the unnecessary space from the voxel group in the generation space. It is assumed that the imaging apparatus 603 is arranged at the position in the virtual space, which corresponds to the position at which the imaging apparatus 103 is arranged, and the image capturing parameters of the imaging apparatus 603 are the same as those of the imaging apparatus 103. In FIG. 6C and FIG. 6D, the unnecessary area mask image 600 arranged in the virtual space in accordance with the image capturing viewing angle of the imaging apparatus 603 is shown. The unnecessary area deletion unit 214 deletes the voxels from the voxel group 610, which are shielded by the area 602, which is the mask area of the unnecessary area mask image 600, in a case where the voxels are viewed from the imaging apparatus 603 by using the image capturing parameters of the imaging apparatus 103 and the data of the unnecessary area mask image 600. In this manner, the unnecessary area deletion unit 214 generates a generation space after deletion 620.

In the above-described explanation, the case is explained where the one imaging apparatus 103 belongs to the first imaging apparatus group, but the two or more imaging apparatuses 103 may belong to the first imaging apparatus group. In a case where a plurality of the imaging apparatuses 103 belongs to the first imaging apparatus group, the unnecessary area deletion unit 214 deletes the voxels shielded by one of the mask areas from the voxel group 610 by using the image capturing parameters of each of the plurality of the imaging apparatuses 103 and the unnecessary area mask image data.

After S503, at S504, the foreground data obtaining unit 211 obtains the foreground data that is output by each first image processing apparatus 110. Specifically, the foreground data obtaining unit 211 obtains the foreground data that is output by the first image processing apparatus 110 connected to the imaging apparatus 103 belonging to the second imaging apparatus group. It may also be possible for the foreground data obtaining unit 211 to obtain the foreground data that is output by the first image processing apparatus 110 connected to the imaging apparatus 103 belonging to the first imaging apparatus group. Next, at S505, the shape generation unit 215 generates three-dimensional shape data by the visual hull method by using the foreground silhouette image data included in the foreground data obtained at S504 and the image capturing parameters obtained at S502. The voxels in the unnecessary spatial area are deleted in advance at S503, and therefore, it is possible to reduce the amount of calculation of the generation of three-dimensional shape data in the shape generation unit 215. Further, the voxel in the unnecessary spatial area are deleted in advance at S503, and therefore, it is possible to suppress unintended three-dimensional shape data from being generated in the unnecessary space.

After S505, at S506, the virtual viewpoint obtaining unit 216 obtains virtual viewpoint information. Next, at S507, the image generation unit 217 generates a virtual viewpoint image. Next, at S508, the image output unit 218 outputs the signal of the virtual viewpoint image and for example, causes the display unit 305 to display the virtual viewpoint image. After S508, the second image processing apparatus 100 terminates the processing of the flowchart shown in FIG. 5. In a case where the imaging apparatus 103 captures a moving image, for example, the second image processing apparatus 100 returns to S504 after the termination of the processing of the flowchart and repeatedly performs the processing at S504 to S508 until instructions to terminate the generation of a virtual viewpoint image are input from the operation unit 306. In this case, for example, the unnecessary area deletion unit 214 causes the auxiliary storage device 304 or the like to store the voxel data indicating the voxel group in the generated generation space after deletion. The shape generation unit 215 generates three-dimensional shape data by duplicating the voxel data stored in the auxiliary storage device 304 or the like. According to the second image processing apparatus 100 configured as above, it is possible to omit the processing to generate a generation space after deletion for each frame.

According to the second image processing apparatus 100 configured as above, it is possible to reduce the amount of calculation in a case where three-dimensional shape data is generated. Further, according to the second image processing apparatus 100 configured as above, it is possible to suppress unintended three-dimensional shape data from being generated in the unnecessary space.

### Embodiment 2

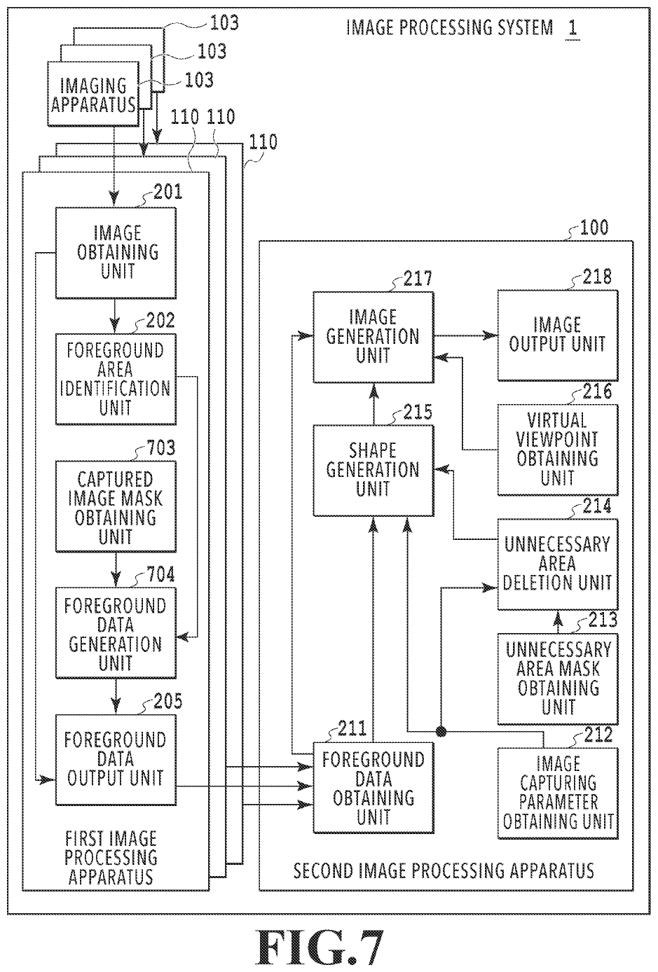

With reference to FIG. 7 to FIG. 9C, the image processing system 1 according to Embodiment 2 is explained. The image processing system 1 according to Embodiment 2 comprises the first image processing apparatus 110 and the second image processing apparatus 100 as shown as one example in FIG. 7. The first image processing apparatus 110 according to Embodiment 1 generates a foreground silhouette image based on the foreground area identified in the captured image. In contrast to this, the first image processing apparatus 110 according to Embodiment 2 (in the following, simply described as “first image processing apparatus 110”) first takes the generated foreground silhouette image as the temporary foreground silhouette image as in the case of the first image processing apparatus 110 according to Embodiment 1 and following this, the first image processing apparatus 110 generates a foreground silhouette image by masking the image area in which the actually existing space corresponding to the unnecessary spatial area is captured in the temporary foreground silhouette image.

### Configuration of First Image Processing Apparatus and Second Image Processing Apparatus

FIG. 7 is a block diagram showing one example of the function configuration of the first image processing apparatus 110 according to Embodiment 2 (in the following, simply described as “first image processing apparatus 110”) and the second image processing apparatus 100 according to Embodiment 2 (in the following, simply described as “second image processing apparatus 100”). The first image processing apparatus 110 comprises the image obtaining unit 201, the foreground area identification unit 202, a captured image mask obtaining unit 703, a foreground data generation unit 704, and the foreground data output unit 205. The second image processing apparatus 100 is the same as the second image processing apparatus 100 according to Embodiment 1. In FIG. 7, to the same configuration as that in FIG. 2, the same symbol as that in FIG. 2 is attached and explanation thereof is omitted.

The processing of each unit comprised by the first image processing apparatus 110 as the function configuration is performed by hardware, such as an ASIC or an FPGA, which is incorporated in the first image processing apparatus 110 as in the case of the first image processing apparatus 110 according to Embodiment 1. Further, the processing may be performed by software using a memory and a processor. In the following, explanation is given on the assumption that the first image processing apparatus 110 includes a computer comprising the hardware shown as one example in FIG. 3.

### Processing of First Image Processing Apparatus

The captured image mask obtaining unit 703 obtains the data (in the following, called “captured image mask image data”) of the mask image (in the following, called “captured image mask image”) for masking the image area in which the actually existing space corresponding to the unnecessary spatial area is captured in the captured image. Here, the actually existing space corresponding to the unnecessary spatial area is, for example, the space obtained by removing the space 107 from the space 106 shown in FIG. 1. Specifically, the captured image mask obtaining unit 703 obtains the captured image mask image data corresponding to each imaging apparatus 103 belonging to the second imaging apparatus group. It may also be possible for the captured image mask obtaining unit 703 to obtain the captured image mask image data corresponding to each imaging apparatus 103 belonging to the first imaging apparatus group, in addition to the captured image mask image data corresponding to each imaging apparatus 103 belonging to the second imaging apparatus group. In the following, explanation is given on the assumption that the captured image mask obtaining unit 703 obtains the captured image mask image data corresponding to each imaging apparatus 103 belonging to the first imaging apparatus group and that corresponding to each imaging apparatus 103 belonging to the second imaging apparatus group. It is possible for a user to prepare in advance the captured image mask image data corresponding to each imaging apparatus 103 by supposing in advance the image capturing parameters, such as the position, the direction of the optical axis, and the viewing angle, of each imaging apparatus 103 and the position of the space 107.

The foreground data generation unit 704 generates a foreground silhouette image based on the information indicating the foreground area identified by the foreground area identification unit 202 and the captured image mask image data obtained by the captured image mask obtaining unit 703 and takes the generated foreground silhouette image data as the foreground data. Specifically, for example, first, the foreground data generation unit 704 generates a temporary foreground silhouette image based on the foreground area identified by the foreground area identification unit 202. Following the above, the foreground data generation unit 704 generates a foreground silhouette image in which all the image areas in which the actually existing space corresponding to the unnecessary spatial area is captured become at least background areas by masking the generated temporary foreground silhouette image by using the captured image mask image.

It may also be possible for the foreground data generation unit 704 to generate, in addition to the foreground silhouette image, the data of the foreground texture (foreground texture data) obtained by extracting the image area corresponding to the foreground area in the foreground silhouette image from the captured image. The foreground data output unit 205 outputs the foreground silhouette image data as the foreground data. Specifically, the foreground data output unit 205 outputs the foreground data by including, in addition to the foreground silhouette image data, the captured image data used in a case where the foreground silhouette image is generated or the foreground texture data generated by the foreground data generation unit 704 in the foreground data.

### Operation of First Image Processing Apparatus

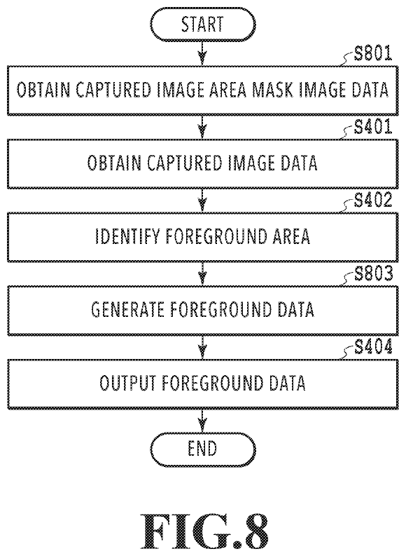

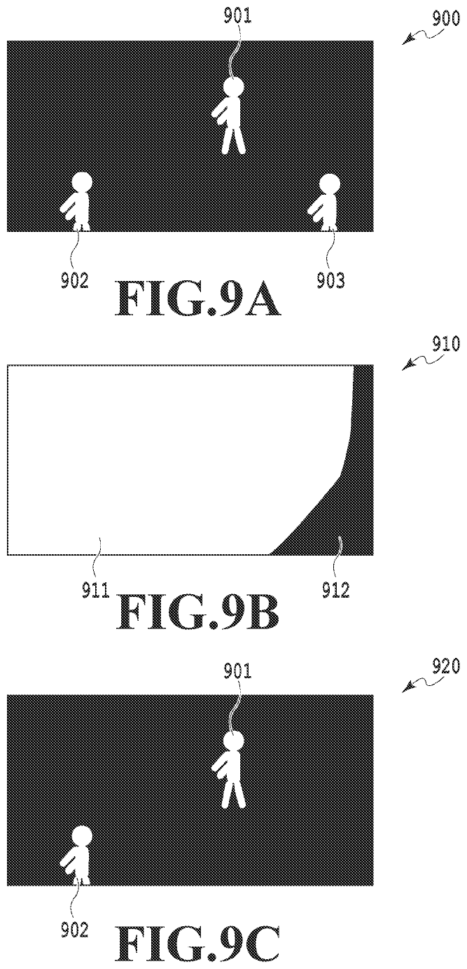

With reference to FIG. 8 to FIG. 9C, the operation of the first image processing apparatus 110 is explained. FIG. 8 is a flowchart showing one example of a processing flow of the first image processing apparatus 110 according to Embodiment 2. In FIG. 8, to the same processing as that at the step shown in FIG. 4, the same symbol is attached and explanation thereof is omitted. The first image processing apparatus 110 repeatedly performs the processing of the flowchart while the second image processing apparatus 100 continues to generate a virtual viewpoint image. First, at S801, the captured image mask obtaining unit 703 obtains the captured image mask image data corresponding to each imaging apparatus 103. After S801, the first image processing apparatus 110 performs the processing at S401 and S402. After S402, at S803, the foreground data generation unit 704 generates foreground image data including the foreground silhouette image data by using the captured image mask image data obtained at S801.

FIG. 9A is a diagram showing one example of a temporary foreground silhouette image 900 generated based on the captured image obtained by image capturing by one of the imaging apparatuses 103. In the temporary foreground silhouette image 900, three foreground areas 901, 902, and 903 each corresponding to the foreground object are included. FIG. 9B is a diagram showing one example of a captured image mask image 910 corresponding to the one of the imaging apparatuses 103. The captured image mask image 910 includes an area 912, which is a mask area masking the image area in which the actually existing space corresponding to the unnecessary spatial area is captured, and an area 911 that does not mask the image area. FIG. 9C is a diagram showing one example of a foreground silhouette image 920 generated by the foreground data generation unit 704. The foreground data generation unit 704 generates the foreground silhouette image 920 by masking the foreground area 903 included in the area 912 of the foreground areas 901, 902, and 903 by masking the temporary foreground silhouette image 900 by using the captured image mask image 910. In the foreground silhouette image 920, the foreground areas 901 and 902 included in the temporary foreground silhouette image 900 are included, but the foreground area 903 is not included.

After S803, at S404, the foreground data output unit 205 outputs the foreground data generated at S803. After S404, the first image processing apparatus 110 terminates the processing of the flowchart shown in FIG. 8 and after the termination, returns to S801 and repeatedly performs the processing of the flowchart while the second image processing apparatus 100 continues to generate a virtual viewpoint image. In a case where the imaging apparatus 103 captures a moving image, it may also be possible for the first image processing apparatus 110 to return to S401 after the termination of the processing of the flowchart and repeatedly perform the processing at S401 to S404 while the second image processing apparatus 100 continues to generate a virtual viewpoint image. In this case, for example, the captured image mask obtaining unit 703 stores in advance the obtained captured image mask image data in the RAM 303 or the like and the foreground data generation unit 704 generates the foreground silhouette image by using the captured image mask image data stored in the RAM 303 or the like. According to the first image processing apparatus 110 configured as above, it is possible to omit the processing to obtain captured image mask image data for each frame.

The second image processing apparatus 100 generates three-dimensional shape data by using the foreground silhouette image generated by the foreground data generation unit 704. In the foreground silhouette image generated by the foreground data generation unit 704, in the image area in which the actually existing space corresponds to the unnecessary spatial area is captured, the foreground area does not exist. Because of this, compared to the second image processing apparatus 100 according to Embodiment 1, it is possible for the second image processing apparatus 100 to further suppress the generation of three-dimensional shape data in the unnecessary spatial area.

### Embodiment 3

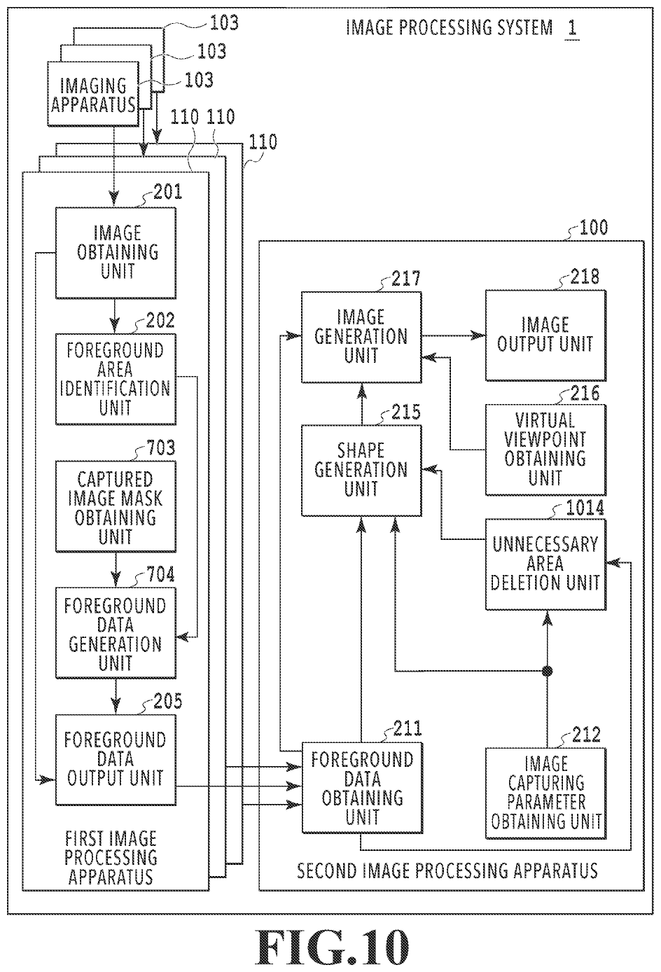

With reference to FIG. 10 to FIG. 12F, the image processing system 1 according to Embodiment 3 is explained. As shown in FIG. 10 as one example, the image processing system 1 according to Embodiment 3 comprises the first image processing apparatus 110 and the second image processing apparatus 100. The second image processing apparatus 100 according to Embodiment 1 deletes the voxels in the unnecessary space from the voxel group in the generation space by using the unnecessary area mask image data. In contrast to this, the second image processing apparatus 100 according to Embodiment 3 deletes the voxels in the unnecessary space from the voxel group in the generation space by using the foreground silhouette image data corresponding to the imaging apparatus 103 belonging to the second imaging apparatus group.

### Configuration of First Image Processing Apparatus and Second Image Processing Apparatus

FIG. 10 is a block diagram showing one example of the function configuration of the first image processing apparatus 110 according to Embodiment 3 (in the following, simply described as “first image processing apparatus 110”) and the second image processing apparatus 100 according to Embodiment 3 (in the following, simply described as “second image processing apparatus 100”). The first image processing apparatus 110 is the same as the first image processing apparatus 110 according to Embodiment 2. It is assumed that the captured image mask obtaining unit 703 of the first image processing apparatus 110 obtains the captured image mask image data corresponding to each imaging apparatus 103 belonging to the first imaging apparatus group and corresponding to each imaging apparatus 103 belonging to the second imaging apparatus group. Further, it is assumed that the foreground data generation unit 704 generates foreground data including the foreground silhouette image data corresponding to each imaging apparatus 103 belonging to the first imaging apparatus group and corresponding to each imaging apparatus 103 belonging to the second imaging apparatus group.

The second image processing apparatus 100 comprises the foreground data obtaining unit 211, the image capturing parameter obtaining unit 212, an unnecessary area deletion unit 1014, the shape generation unit 215, the virtual viewpoint obtaining unit 216, the image generation unit 217, and the image output unit 218. In FIG. 10, to the same configuration as that in FIG. 2 or FIG. 7, the same symbol as that in FIG. 2 or FIG. 7 is attached and explanation therefore is omitted. The processing of each unit comprised by the second image processing apparatus 100 as the function configuration is performed by hardware, such as an ASIC or an FPGA, which is incorporated in the second image processing apparatus 100, as in the case of the second image processing apparatus 100 according to Embodiment 1. Further, the processing may be performed by software using a memory and a processor. In the following, explanation is given on the assumption that the second image processing apparatus 100 includes a computer comprising the hardware shown as one example in FIG. 3.

### Processing of Second Image Processing Apparatus

The unnecessary area deletion unit 1014 deletes the unnecessary space from the generation space by using the foreground silhouette image data included in the foreground data corresponding to the imaging apparatus 103 belonging to the first imaging apparatus group, among the foreground data that is obtained by the foreground data obtaining unit 211. Specifically, first, the unnecessary area deletion unit 1014 identifies the area corresponding to the unnecessary space from the generation space by using the foreground silhouette image data corresponding to the imaging apparatus 103 belonging to the first imaging apparatus group and the image capturing parameters of the imaging apparatus 103. Following the above, the unnecessary area deletion unit 1014 generates a generation space after deletion by deleting the identified area from the generation space. The deletion method of an unnecessary space using foreground silhouette image data and image capturing parameters will be described later.

### Operation of Second Image Processing Apparatus

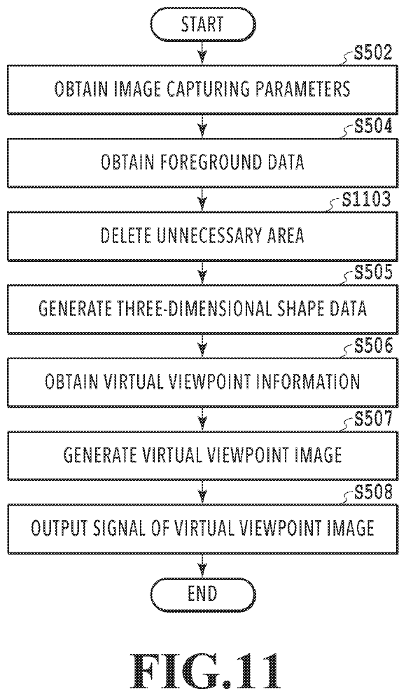

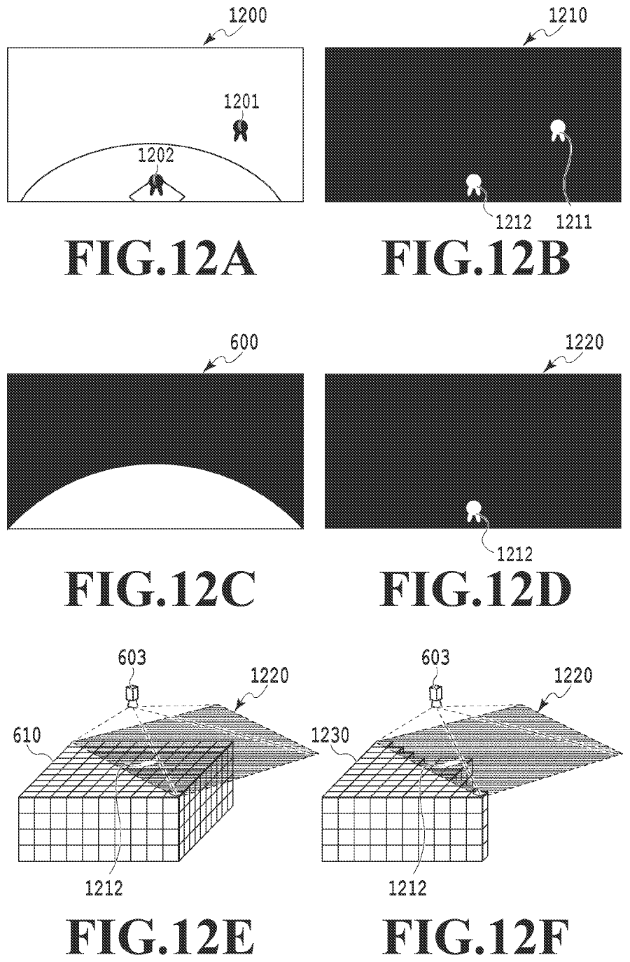

With reference to FIG. 11 and FIG. 12A to FIG. 12F, the operation of the second image processing apparatus 100 is explained. FIG. 11 is a flowchart showing one example of a processing flow of the second image processing apparatus 100 according to Embodiment 3. The second image processing apparatus 100 repeatedly performs the processing of the flowchart until, for example, instructions to terminate the generation of a virtual viewpoint image are input from the operation unit 306. In FIG. 11, to the same processing as that at the step shown in FIG. 5, the same symbol is attached and explanation thereof is omitted. First, the second image processing apparatus 100 performs the processing at S502 and S504. After S504, at S1103, the unnecessary area deletion unit 1014 deletes the voxels in the unnecessary space from the voxel group in the generation space by using the foreground silhouette image data included in the foreground data obtained at S504 and the image capturing parameters obtained at S502. Specifically, the unnecessary area deletion unit 1014 first identifies the area corresponding to the unnecessary space from the generation space by using the foreground silhouette image data and the image capturing parameters. Following the above, the unnecessary area deletion unit 1014 deletes the voxels corresponding to the identified area from the voxel group in the generation space.

With reference to FIG. 12A to FIG. 12F, the method of deleting voxels in an unnecessary space from a voxel group in a generation space is explained. In FIG. 12C, FIG. 12E, and FIG. 12F, to the same configuration as that shown FIG. 6D, the same symbol is attached and explanation thereof is omitted. FIG. 12A is a diagram showing one example of a captured image 1200 obtained by image capturing by the imaging apparatus 103 belonging to the first imaging apparatus group. In the captured image 1200, foreground objects 1201 and 1202 are captured. FIG. 12B is a diagram showing one example of a temporary foreground silhouette image 1210 that is generated by the foreground data generation unit 704 of the first image processing apparatus 110. In the temporary foreground silhouette image 1210, foreground areas 1211 and 1212 corresponding to the image areas in which the foreground objects 1201 and 1202 are captured in the captured image 1200 exist.

FIG. 12C is a diagram showing one example of the unnecessary area mask image 600 for masking the image area in which the actually existing space corresponding to the unnecessary space is captured in the captured image 1200. The data of the unnecessary area mask image 600 is obtained by the captured image mask obtaining unit 703 of the first image processing apparatus 110 as the captured image mask image data. FIG. 12D is a diagram showing one example of a foreground silhouette image 1220 that is generated by the foreground data generation unit 704 of the first image processing apparatus 110. In the foreground silhouette image 1220, the foreground area 1211 of the foreground areas 1211 and 1212 in the temporary foreground silhouette image 1210 is masked by the unnecessary area mask image 600 and in the foreground silhouette image 1220, only the foreground area 1212 exists.

FIG. 12E is a diagram showing one example of the way the virtual imaging apparatus 603 in the virtual space, which corresponds to the imaging apparatus 103 belonging to the first imaging apparatus group, captures the voxel group 610 in the generation space corresponding to the space 106. FIG. 12F is a diagram showing one example of the way the unnecessary area deletion unit 1014 according Embodiment 3 deletes the voxels in the unnecessary space from the voxel group in the generation space. In FIG. 12E and FIG. 12F, the foreground silhouette image 1220 arranged in the virtual space in accordance with the image capturing viewing angle of the virtual imaging apparatus 603 is shown. The unnecessary area deletion unit 1014 deletes the voxels from the voxel group 610, which are shielded by the background area of the foreground silhouette image 1220 in a case where the voxels are viewed from the imaging apparatus 603 by using the image capturing parameters of the imaging apparatus 103 and the data of the foreground silhouette image 1220. In this manner, the unnecessary area deletion unit 1014 generates a generation space after deletion 1230.

In the above described explanation, the case is explained where the one imaging apparatus 103 belongs to the first imaging apparatus group, but the two or more imaging apparatuses 103 may belong to the first imaging apparatus group. In a case where a plurality of the imaging apparatuses 103 belongs to the first imaging apparatus group, the unnecessary area deletion unit 1014 deletes the voxels from the voxel group 610, which are shielded by one of the background areas, by using the image capturing parameters of each of the plurality of the imaging apparatuses 103 and the foreground silhouette image data. After S1103, the second image processing apparatus 100 performs the processing at S504 to S508. After S508, the second image processing apparatus 100 terminates the processing of the flowchart shown in FIG. 11. After the termination of the processing of the flowchart, the second image processing apparatus 100 returns to S502 and repeatedly performs the processing at S502 to S508 until instructions to terminate the generation of a virtual viewpoint image are input from the operation unit 306.

According to the second image processing apparatus 100 configured as above, it is possible to reduce the amount of calculation in a case where three-dimensional shape data is generated. Further, according to the second image processing apparatus 100 configured as above, in the foreground silhouette image 1220, the foreground area does not exist, which corresponds to the foreground object existing in the actually existing space corresponding to the unnecessary space. Because of this, it is possible to suppress unintended three-dimensional shape data from being generated in the unnecessary space. Further, the number of voxels to be deleted at S1103 is larger than or equal to the number of voxels to be deleted at S502 in Embodiment 1 or Embodiment 2, and therefore, compared to Embodiment 1 or Embodiment 2, it is possible to further reduce the amount of calculation to generate three-dimensional shape data.

### Embodiment 4

The second image processing apparatus 100 according to Embodiment 1 or Embodiment 2 deletes the voxels in the unnecessary space from the voxel group in the generation space by using the unnecessary area mask image data. Here, the unnecessary area mask image data according to Embodiment 1 or Embodiment 2 is for masking the image area in which the actually existing space corresponding to the unnecessary spatial area is captured in the captured image obtained by image capturing by the actually existing imaging apparatus 103 belonging to the first imaging apparatus group. Further, the second image processing apparatus 100 according to Embodiment 3 deletes the voxels in the unnecessary space from the voxel group in the generation space by using the foreground silhouette image data. Here, the foreground silhouette image data that is used to delete the voxels in the unnecessary space is generated based on the captured image obtained by image capturing by the actually existing imaging apparatus belonging to the first imaging apparatus group.

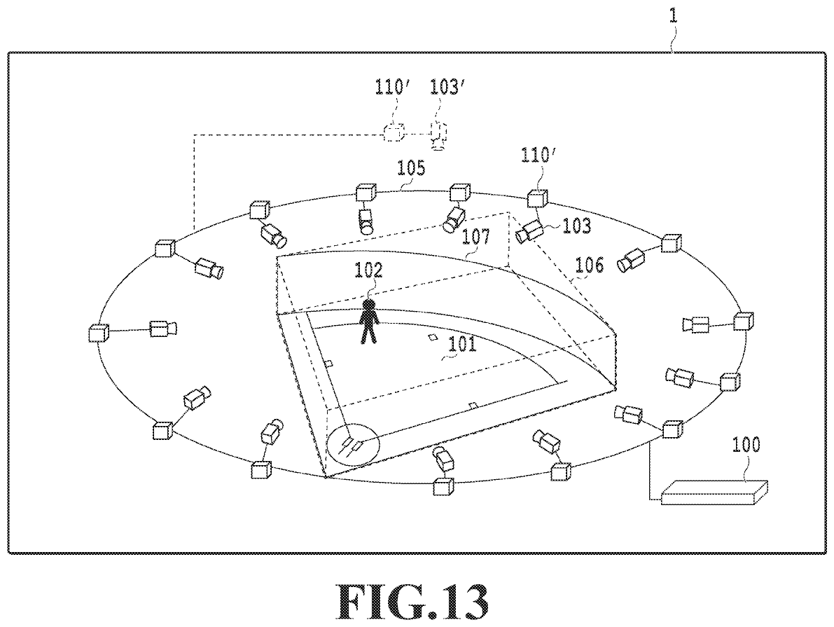

However, depending on the facilities, such as the sports stadium, which are the generation target of a virtual viewpoint image, there is a case where restrictions are imposed on the installation position of the imaging apparatus 103, and therefore, it is not possible to install the imaging apparatus 103 belonging to the first imaging apparatus group, which is used in a case where the voxels in the unnecessary space are deleted. In Embodiment 4, with reference to FIG. 13 to FIG. 15, the image processing system 1 is explained, which enables to delete the voxels in the unnecessary space even in a case where the imaging apparatus 103 belonging to the first imaging apparatus group does not exist actually.

### System Configuration

FIG. 13 is a diagram for explaining one example of the configuration of the image processing system 1 according to Embodiment 4. In FIG. 13, to the same configuration as that in FIG. 1, the same symbol as that in FIG. 1 is attached and explanation thereof is omitted. An imaging apparatus 103′ is an imaginary imaging apparatus not existing actually and belonging to the first imaging apparatus group, which is assumed to perform imaginary image capturing by using the same image capturing parameters as those of the imaging apparatus 103 shown at the same position in FIG. 1. The imaging apparatus 103′ shown in FIG. 13 is an imaginary imaging apparatus, and therefore, is schematically shown for convenience in accordance with the imaging apparatus 103. By supposing in advance the image capturing parameters, such as the position, the direction of the optical axis, and the viewing angle, of the imaging apparatus 103′, it is also possible to prepare in advance the unnecessary area mask image data the same as the data of the unnecessary area mask image 600 shown as one example in FIG. 6A for the imaging apparatus 103′. A first image processing apparatus 110′ shown in FIG. 13 is an imaginary apparatus not existing actually and schematically shown for convenience in accordance with the first image processing apparatus 110 connected to the imaging apparatus 103.

In the following, explanation is given on the assumption that all the imaging apparatuses 103 belonging to the first imaging apparatus group are changed to the imaging apparatuses 103′, which are imaginary imaging apparatuses, and all the actually existing imaging apparatuses 103 belong to the second imaging apparatus group. However, part of the imaging apparatuses 103 belonging to the first imaging apparatus group may be changed to the imaging apparatuses 103′, which are imaginary imaging apparatuses, and the rest may remain the actually existing imaging apparatuses 103. In this case, it is sufficient to perform the same processing as that of the image processing system 1 according to one of Embodiment 1 to Embodiment 3 for the captured image obtained by image capturing by the actually existing imaging apparatuses 103 belonging to the first image capturing apparatus group.

### Configuration of First Image Processing Apparatus and Second Image Processing Apparatus

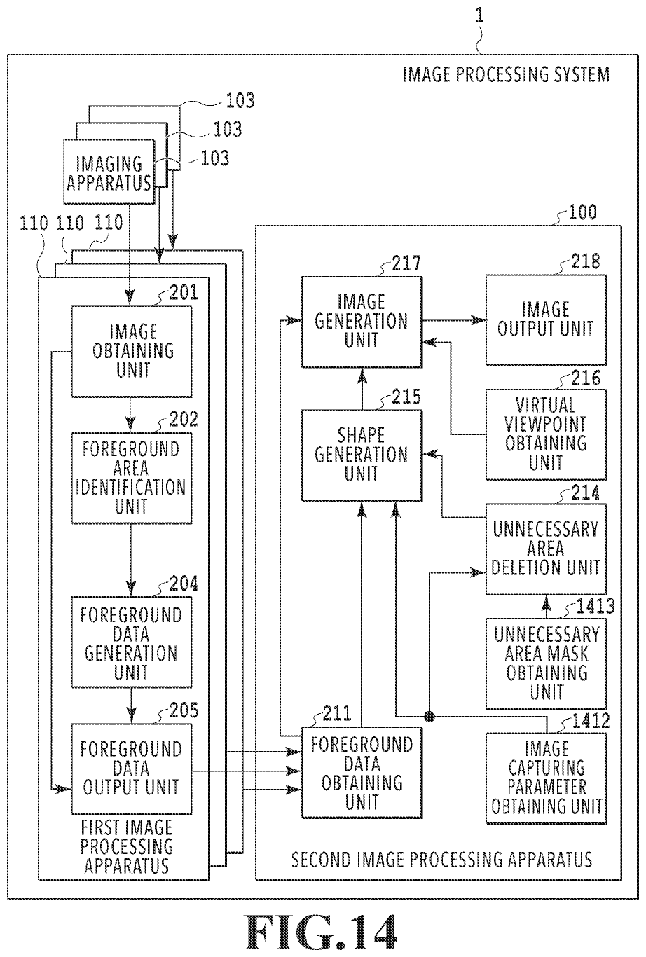

FIG. 14 is a block diagram showing one example of the function configuration of the first image processing apparatus 110 according to Embodiment 4 (in the following, simply described as “first image processing apparatus 110) and the second image processing apparatus 100 according to Embodiment 4 (in the following, simply described as “second image processing apparatus 100”). The first image processing apparatus 110 is the same as the first image processing apparatus 110 according to Embodiment 1. In the present embodiment, the first image processing apparatus 110 may be the same as the first image processing apparatus 110 according to Embodiment 2 or Embodiment 3. The second image processing apparatus 100 comprises the foreground data obtaining unit 211, an image capturing parameter obtaining unit 1412, an unnecessary area mask obtaining unit 1413, the unnecessary area deletion unit 214, the shape generation unit 215, the virtual viewpoint obtaining unit 216, the image generation unit 217, and the image output unit 218. In FIG. 14, to the same configuration as that in FIG. 2 or FIG. 7, the same symbol as that in FIG. 2 or FIG. 7 is attached and explanation thereof is omitted.

The processing of each unit comprised by the second image processing apparatus 100 as the function configuration is performed by hardware, such as an ASIC or an FPGA, which is incorporated in the second image processing apparatus 100, as in the case of the second image processing apparatus 100 according to Embodiment 1 to Embodiment 3. Further, the processing may be performed by software using a memory and a processor. In the following, explanation is given on the assumption that the second image processing apparatus 100 includes a computer comprising the hardware shown as one example in FIG. 3.

### Processing of Second Image Processing Apparatus

The image capturing parameter obtaining unit 1412 obtains the image capturing parameters of each imaging apparatus 103 belonging to the second imaging apparatus group by reading them from, for example, the auxiliary storage device 304 or the like. Further, the image capturing parameter obtaining unit 1412 also obtains the image capturing parameters corresponding to the imaging apparatus 103′, which is an imaginary imaging apparatus. The image capturing parameters corresponding to the imaging apparatus 103′ are stored in advance in, for example, the auxiliary storage device 304 or the like and the image capturing parameter obtaining unit 1412 obtains the image capturing parameters corresponding to the imaging apparatus 103′ by reading them. In a case where the actually existing imaging apparatus 103 belonging to the first imaging apparatus group exists, the image capturing parameter obtaining unit 1412 also obtains the image capturing parameters of each imaging apparatus 103 belonging to the first imaging apparatus group by reading them from the auxiliary storage device 304 or the like.

Here, the imaging apparatus 103′ is an imaginary imaging apparatus, and therefore, it is possible to set the image capturing parameters, such as the position, the direction of the optical axis, and the viewing angle, of the imaging apparatus 103′ to image capturing parameters with which it is possible to effectively delete the voxels in the unnecessary spatial area. It is possible to easily find the image capturing parameters, such as the position, the direction of the optical axis, and the viewing angle, with which it is possible to effectively delete the voxels in the unnecessary spatial area, by using a general three-dimensional modeling tool. Further, for example, it may also be possible to set distortion parameters of the image capturing parameters corresponding to the imaging apparatus 103′ on the assumption that there are not lens distortions.

The unnecessary area mask obtaining unit 1413 obtains the unnecessary area mask image data corresponding to the imaging apparatus 103′. The unnecessary area mask image data corresponding to the imaging apparatus 103′ is stored in advance in, for example, the auxiliary storage device 304 and the unnecessary area mask obtaining unit 1413 obtains the unnecessary area mask image data corresponding to the imaging apparatus 103′ by reading them. In a case where the actually existing imaging apparatus 103 belonging to the first imaging apparatus group exists, the unnecessary area mask obtaining unit 1413 also obtains the unnecessary area mask image data corresponding to the imaging apparatus 103 by reading them from the auxiliary storage device 304 or the like.

### Operation of Second Image Processing Apparatus

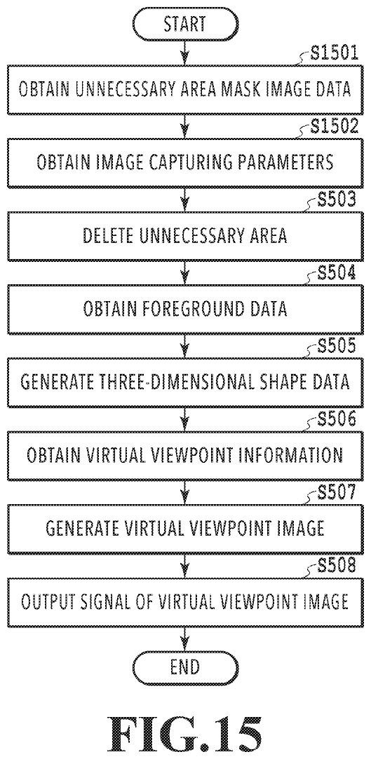

With reference to FIG. 15, the operation of the second image processing apparatus 100 is explained. FIG. 15 is a flowchart showing one example of a processing flow of the second image processing apparatus 100 according to Embodiment 4. The second image processing apparatus 100 repeatedly performs the processing of the flowchart until, for example, instructions to terminate the generation of a virtual viewpoint image are input from the operation unit 306. In FIG. 15, to the same processing as that at the step shown in FIG. 5, the same symbol is attached and explanation thereof is omitted.

First, at S1501, the unnecessary area mask obtaining unit 1413 obtains the unnecessary area mask image data corresponding to the imaging apparatus 103′. In a case where the imaging apparatus 103 belonging to the first imaging apparatus group exists, the unnecessary area mask obtaining unit 1413 also obtains the unnecessary area mask image data corresponding to the imaging apparatus 103. Next, at S1502, the image capturing parameter obtaining unit 1412 obtains the image capturing parameters of each imaging apparatus 103 belonging to the second imaging apparatus group and the image capturing parameters corresponding to the imaging apparatus 103′. In a case where the imaging apparatus 103 belonging to the first imaging apparatus group exists, the image capturing parameter obtaining unit 1412 also obtains the image capturing parameters of the imaging apparatus 103.

Next, at S503, the unnecessary area deletion unit 214 deletes the voxels in the unnecessary space from the voxel group in the generation space by using the unnecessary area mask image data obtained at S1501 and the image capturing parameters obtained at S1502. Specifically, the unnecessary area deletion unit 214 first identifies the area corresponding to the unnecessary space from the generation space by using the unnecessary area mask image data and the image capturing parameters. Following the above, the unnecessary area deletion unit 214 deletes the voxels corresponding to the identified area from the voxel group in the generation space. After S503, the second image processing apparatus 100 performs the processing at S504 to S508. After S508, the second image processing apparatus 100 terminates the processing of the flowchart shown in FIG. 15. In a case where the imaging apparatus 103 captures a moving image, for example, the second image processing apparatus 100 returns to S504 after the termination of the processing of the flowchart and repeatedly performs the processing at S504 to S508 until instructions to terminate the generation of a virtual viewpoint image are input from the operation unit 306.

According to the second image processing apparatus 100 configured as above, it is possible to reduce the amount of calculation in a case where three-dimensional shape data is generated. Particularly, according to the second image processing apparatus 100, by supposing the imaginary imaging apparatus 103′ corresponding to the imaging apparatus 103 belonging to the first imaging apparatus group, even in a case where there are restrictions on the installation of the imaging apparatus 103, it is possible to generate a generation space after deletion. As a result, according to the second image processing apparatus 100, even in the case described above, it is possible to reduce the amount of calculation in a case where three-dimensional shape data is generated.

### Embodiment 5

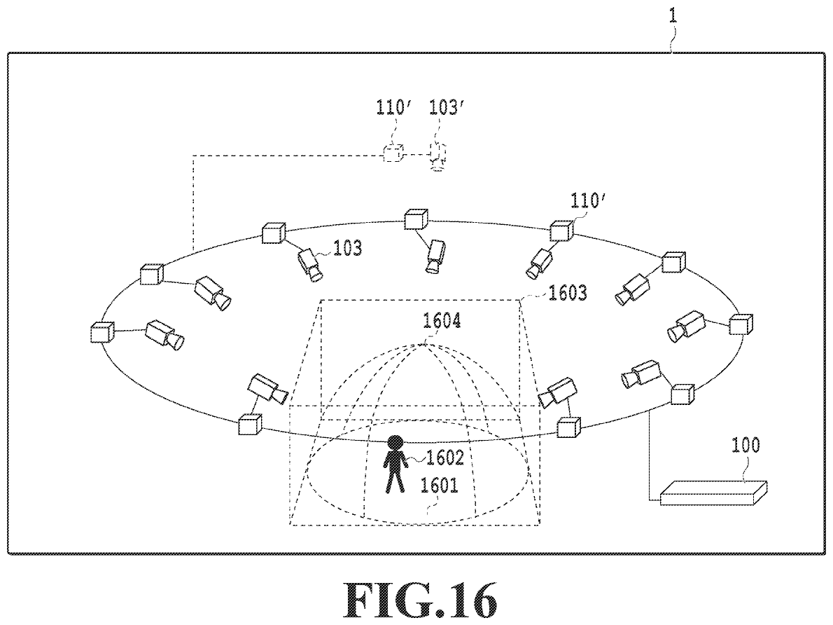

With reference to FIG. 16 to FIG. 19C, the image processing system 1 according to Embodiment 5 is explained. The second image processing apparatus 100 according to Embodiment 1 or Embodiment 2 deletes the voxels in the unnecessary space from the voxel group in the generation space by using the unnecessary area mask image data corresponding to the imaging apparatus 103 belonging to the first imaging apparatus group. Further, the second image processing apparatus 100 according to Embodiment 4 enables the generation of a generation space after deletion even in a case where there are restrictions on the installation of the imaging apparatus 103 by supposing the imaginary imaging apparatus 103′ corresponding to the imaging apparatus 103 belonging to the first imaging apparatus group.

However, in a case where it is attempted to generate a generation space after deletion having a complicated shape, such as a hemispherical shape, by the second image processing apparatus 100 according to Embodiment 1 or Embodiment 2, it is necessary to install a large number of imaging apparatuses 103 belonging to the first imaging apparatus group. Similarly, in a case where it is attempted to generate a generation space after deletion having a complicated shape by the second image processing apparatus 100 according to Embodiment 4, it is necessary to suppose a large number of imaginary imaging apparatuses 103′ corresponding to the large number of imaging apparatuses 103. Further, despite the installation of a large number of imaging apparatuses 103 belonging to the first imaging apparatus group or the supposition of a large number of imaginary imaging apparatuses 103′, there is a case where it is not possible to generate a generation space after deletion having a complicated shape in the surface of which there is a concave portion. In Embodiment 5, the image processing system 1 is explained, which enables the generation of a generation space after deletion having a complicated shape even in a case where the number of installed imaging apparatuses 103 belonging to the first imaging apparatus group is small, or the number of supposed imaginary imaging apparatuses 103′ is small.

### System Configuration

FIG. 16 is a diagram for explaining one example of the configuration of the image processing system 1 according to Embodiment 5. In FIG. 16, to the same configuration as that in FIG. 1 or FIG. 13, the same symbol as that in FIG. 1 or FIG. 13 is attached and explanation thereof is omitted. Explanation is given on the assumption that the image processing system 1 according to Embodiment 5 is the system that supposes the imaging apparatus 103′, which is the imaginary imaging apparatus corresponding to the imaging apparatus 103, as in Embodiment 4, but this is not limited. Specifically, the image processing system 1 according to Embodiment 5 may be the system in which the imaging apparatus 103′ is replaced with the actually existing imaging apparatus 103 and the first image processing apparatus 110′ is replaced with the actually existing first image processing apparatus 110 in FIG. 16. Further, in Embodiment 5, as one example, an aspect is explained in which the image processing system 1 is applied to a dedicated image capturing studio 1601 capable of synchronous image capturing for generating a virtual viewpoint image, not facilities such as a sports stadium. The application destination of the image processing system 1 according to Embodiment 5 is not limited to the image capturing studio 1601.

It is assumed that a person 1602 exists as a foreground object in the image capturing studio 1601. Around the image capturing studio 1601, a plurality of the imaging apparatuses 103 is arranged so as to perform image capturing for the whole of an actually existing space 1603, which corresponds to the generation space in the virtual space. Each imaging apparatus 103 performs synchronous image capturing for the space 1603 from a plurality of viewpoints. A space 1604 is a partial space of the space 1603 and represents an actually existing space having a hemispherical shape, which corresponds to a generation space after deletion in the virtual space, which is used in a case where three-dimensional shape data is generated.

### Configuration of First Image Processing Apparatus and Second Image Processing Apparatus

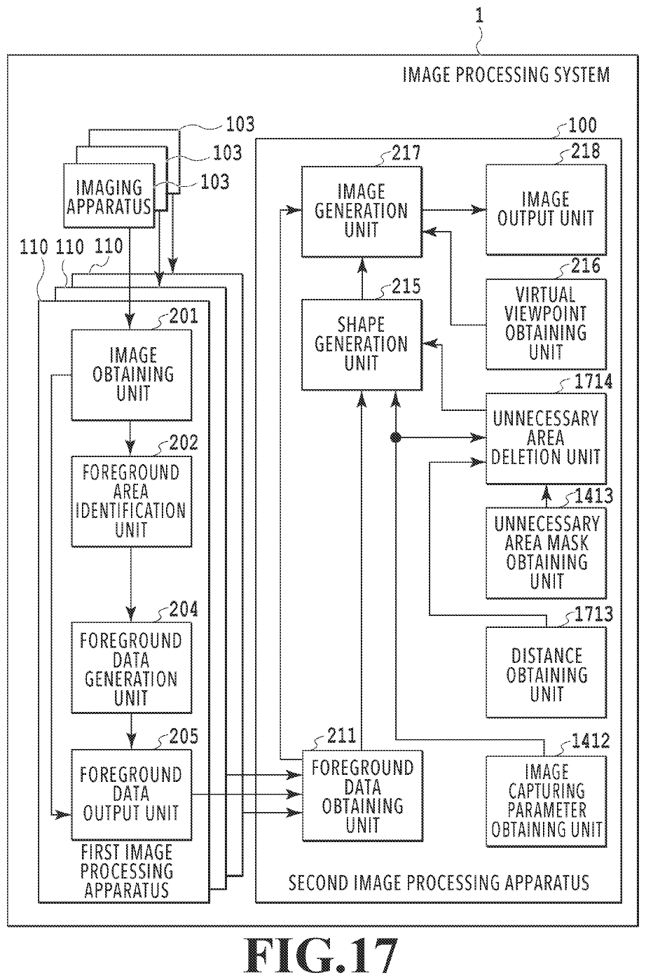

FIG. 17 is a block diagram showing one example of the function configuration of the first image processing apparatus 110 according to Embodiment 5 (in the following, simply described as “first image processing apparatus 110”) and the second image processing apparatus 100 according to Embodiment 5 (in the following, simply described as “second image processing apparatus 100”). The first image processing apparatus 110 is the same as the first image processing apparatus 110 according to Embodiment 4. In the present embodiment, the first image processing apparatus 110 may be the same as the first image processing apparatus 110 according to Embodiment 1 or Embodiment 2. The second image processing apparatus 100 comprises the foreground data obtaining unit 211, the image capturing parameter obtaining unit 1412, the unnecessary area mask obtaining unit 1413, the shape generation unit 215, the virtual viewpoint obtaining unit 216, the image generation unit 217, and the image output unit 218. In addition to the above-described configurations, the second image processing apparatus 100 also comprises a distance obtaining unit 1713 and an unnecessary area deletion unit 1714. In FIG. 17, to the same configuration as that in FIG. 14, the same symbol as that in FIG. 14 is attached and explanation thereof is omitted.

In FIG. 16, in a case where the imaging apparatus 103′ and the first image processing apparatus 110′ are replaced with the imaging apparatus 103 and the first image processing apparatus 110, it is sufficient to perform the following replacement in FIG. 17. Specifically, it is sufficient to replace the image capturing parameter obtaining unit 1412 and the unnecessary area mask obtaining unit 1413 with the image capturing parameter obtaining unit 212 and the unnecessary area mask obtaining unit 213. The processing of each unit comprised by the second image processing apparatus 100 as the function configuration is performed by hardware, such as an ASIC or an FPGA, which is incorporated in the second image processing apparatus 100 as in the case of the second image processing apparatus 100 according to Embodiment 4. Further, the processing may be performed by software using a memory and a processor. In the following, explanation is given on the assumption that the second image processing apparatus 100 includes a computer comprising the hardware shown as one example in FIG. 3.

### Processing of Second Image Processing Apparatus

The distance obtaining unit 1713 obtains information (in the following, called “distance information”) from the position of the imaging apparatus 103′ to the boundary surface between the actually existing space 1604 corresponding to the generation space after deletion and the actually existing space corresponding to the unnecessary space, that is, from the position of the imaging apparatus 103′ to each point on the surface of the space 1604. Specifically, the distance obtaining unit 1713 obtains data of a depth map as distance information, which indicates the distance from the position of the imaging apparatus 103′ to each point on the boundary surface between the space 1604 and the actually existing space corresponding to the unnecessary space. For example, first, the distance obtaining unit 1713 obtains information (in the following, called “boundary surface information”) indicating the position of the boundary surface between the space 1604 and the actually existing space corresponding to the unnecessary space. Specifically, the boundary surface information is created in advance and the distance obtaining unit 1713 obtains the boundary surface information by reading the boundary surface information stored in advance in the auxiliary storage device 304 or the like. Following the above, the distance obtaining unit 1713 obtains the distance information by calculating the distance from the position of the imaging apparatus 103′ to each point on the boundary surface based on the boundary surface information and the position of the imaging apparatus 103′ and generating the depth map indicating the distance from the position of the imaging apparatus 103′.

The boundary surface information may be a mathematical formula or the like

expressing one or more planes or curved surfaces configuring the boundary surface and may be information indicating each of a plurality of polygons configuring the boundary surface, such as triangular polygons. The boundary surface information is not limited to those described above as long as it is possible to identify the position of the boundary surface, and for example, may be information represented by a shape different from the polygon, which is capable of representing the three-dimensional shape of the boundary surface. Further, for example, the boundary surface information may be information indicating the three-dimensional shape of the unnecessary space or information indicating the three-dimensional shape of the generation space after the unnecessary spatial area is deleted as long they are information capable of identifying the position of the boundary surface. Further, it may also be possible for the distance obtaining unit 1713 to obtain data of a depth map as distance information by reading data of the depth map created in advance by using a general three-dimensional modeling tool from the auxiliary storage device 304 or the like.

The unnecessary area deletion unit 1714 deletes the voxels in the unnecessary space from the voxel group in the generation space by using the distance information obtained by the distance obtaining unit 1713, in addition to the unnecessary area mask image data and the image capturing parameters corresponding to the imaging apparatus 103′. Specifically, first, the unnecessary area deletion unit 1714 identifies the area corresponding to the unnecessary space from the generation space by using the unnecessary area mask image data, the image capturing parameters, and the distance information. Following the above, the unnecessary area deletion unit 1714 deletes the voxels corresponding to the identified area from the voxel group in the generation space. By deleting the voxels in the unnecessary space from the voxel group in the generation space by using the distance information, it is possible to generate a generation space after deletion having a complicated shape even in a case where the number of supposed imaginary imaging apparatuses 103′ is small. The specific voxel deletion method in the unnecessary area deletion unit 1714 will be described later.

### Operation of Second Image Processing Apparatus

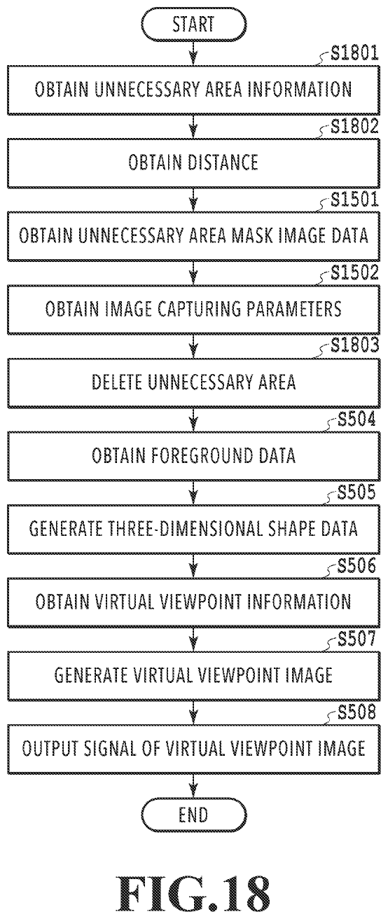

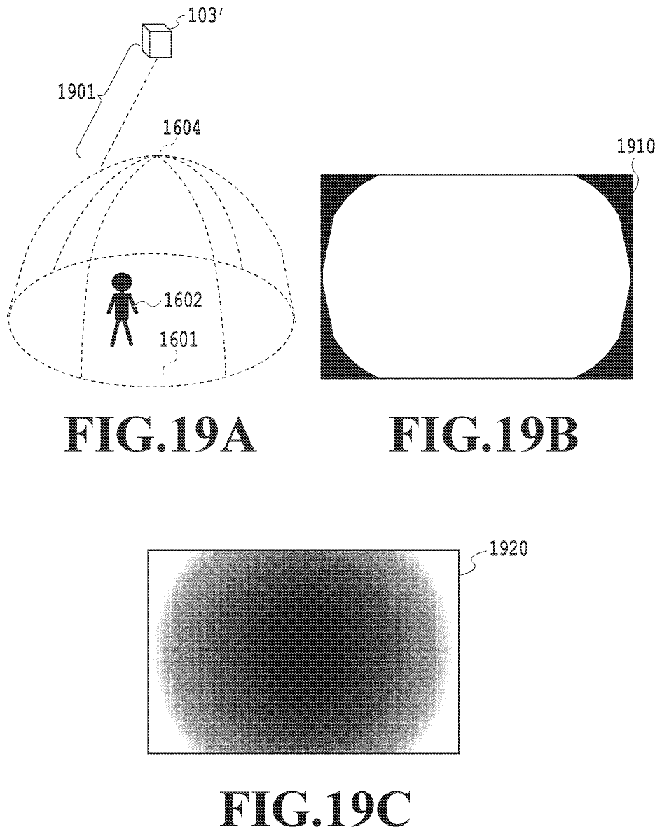

With reference to FIG. 18 and FIG. 19A to FIG. 19C, the operation of the second image processing apparatus 100 is explained. FIG. 18 is a flowchart showing one example of a processing flow of the second image processing apparatus 100 according to Embodiment 5. The second image processing apparatus 100 repeatedly performs the processing of the flowchart until, for example, instructions to terminate the generation of a virtual viewpoint image are input from the operation unit 306. In FIG. 18, to the same processing as that at the step shown in FIG. 15, the same symbol is attached and explanation thereof is omitted. First, at S1801, the distance obtaining unit 1713 obtains boundary surface information. Next, at S1802, the distance obtaining unit 1713 obtains distance information. After S1802, the second image processing apparatus 100 performs the processing at S1501 and S1502. With reference to FIG. 19A to FIG. 19C, the depth map indicating the distance from the position of the imaging apparatus 103′ to each point on the boundary surface between the space 1604 and the actually existing space corresponding to the unnecessary space is explained.

FIG. 19A is a diagram showing one example of a distance 1901 from the position of the imaging apparatus 103′ to a point on the boundary surface between the space 1604 and the actually existing space corresponding to the unnecessary space. The imaging apparatus 103′ is an imaginary imaging apparatus, and therefore, the imaging apparatus 103′ shown in FIG. 19A is shown schematically for convenience in order to indicate the position of the imaging apparatus 103′. For example, the distance obtaining unit 1713 identifies the point on the boundary surface between the space 1604 and the actually existing space corresponding to the unnecessary space in a case where the depth map that is generated is arranged in accordance with the viewing angle of the imaging apparatus 103′ and each pixel of the depth map is projected onto the space 1604 from the position of the imaging apparatus 103′. Further, the distance obtaining unit 1713 calculates the distance 1901 from the position of the imaging apparatus 103′ to the point on the boundary surface between the space 1604 and the actually existing space corresponding to the unnecessary space by using the information indicating the position of the imaging apparatus 103′ and the information indicating the position of each identified point on the boundary surface.

FIG. 19B is a diagram showing one example of an unnecessary area mask image 1910 corresponding to the imaging apparatus 103′ shown in FIG. 19A. The black area in the unnecessary area mask image 1910 is the area corresponding to the image area in which the actually existing space corresponding to the unnecessary space is captured in the captured image that is obtained in a case where the imaging apparatus 103′, which is an imaginary imaging apparatus, performs image capturing. Similarly, the white area in the unnecessary area mask image 1910 is the area corresponding to the image area in which the actually existing space 1604 corresponding to the generation space after deletion is captured in the captured image that is obtained in a case where the imaging apparatus 103′, which is an imaginary imaging apparatus, performs image capturing.

FIG. 19C is a diagram showing one example of a depth map 1920 that is generated by the distance obtaining unit 1713. In FIG. 19C, the distance from the position of the imaging apparatus 103′ to the point on the boundary surface between the space 1604 and the actually existing space corresponding to the unnecessary space is represented by the pixel value in grayscale. As one example, in the depth map 1920 shown in FIG. 19C, the pixel whose pixel value is smaller, that is, the pixel whose color is closer to black indicates that the distance from the position of the imaging apparatus 103′ to the point on the boundary surface between the space 1604 and the actually existing space corresponding to the unnecessary space is shorter. On the contrary, the pixel whose pixel value is larger, that is, the pixel whose color is closer to white indicates that the distance from the position of the imaging apparatus 103′ to the point on the boundary surface between the space 1604 and the actually existing space corresponding to the unnecessary space is longer. It may also be possible to represent the pixel value of the depth map 1920 that is obtained as distance information as a value obtained by normalizing the distance from the imaging apparatus 103′ to the point on the boundary surface between the space 1604 and the actually existing space corresponding to the unnecessary space with a predetermined value.

After S1502, at S1803, the unnecessary area deletion unit 1714 deletes the voxels in the unnecessary space from the voxel group in the generation space by using the distance information, the unnecessary area mask image data, and the image capturing parameters obtained at S1802, S1501, and S1502. Specifically, first, the unnecessary area deletion unit 1714 identifies the area corresponding to the unnecessary space from the generation space by using the distance information, the unnecessary area mask image data, and the image capturing parameters. Following the above, the unnecessary area deletion unit 1714 deletes the voxels corresponding to the identified area from the voxel group in the generation space. The actually existing space 1604 corresponding to the generation space after deletion in the virtual space, which is shown as one example in FIG. 16 and FIG. 19A, has the shape of a hemisphere. However, in a case where the voxels in the unnecessary space are deleted by using only the image capturing parameters and the unnecessary area mask image 1910 as in the case of the second image processing apparatus 100 according to Embodiment 1 or Embodiment 2, the generation space after deletion having the shape of a cylinder is generated. In contrast to this, in the second image processing apparatus 100 according to the present embodiment, by deleting the voxels in the unnecessary space by using the depth map 1920, in addition to the image capturing parameters and the unnecessary area mask image 1910, it is possible to generate the generation space after deletion having the shape of a hemisphere.

Specifically, for example, the unnecessary area deletion unit 1714 deletes the voxels in the unnecessary space from the voxel group in the generation space by the following procedure. The procedure described in the following is merely exemplary and the procedure is not limited to this. First, the unnecessary area deletion unit 1714 deletes the voxels in the unnecessary space from the voxel group in the generation space by using the image capturing parameters and the unnecessary area mask image 1910. By this, the generation space having the shape of a cylinder is generated. Following the above, the unnecessary area deletion unit 1714 identifies the voxel to be deleted from the voxel group in the generation space by arranging the depth map in accordance with the viewing angle of the imaging apparatus 103′ and determining whether or not each voxel in the generation space having the shape of a cylinder is included in the generation space after deletion. It is possible to perform the determination of whether or not a voxel is included in the generation space after deletion by using, for example, formula (1) below.

$$is\_included = \{ \begin{matrix}1 & if \sqrt{{( {x}_{b} - {x}_{c} )}^{2} + {( {y}_{b} - {y}_{c} )}^{2} + {( {z}_{b} - {z}_{c} )}^{2}} > r \\ 0 & if \sqrt{{( {x}_{b} - {x}_{c} )}^{2} + {( {y}_{b} - {y}_{c} )}^{2} + {( {z}_{b} - {z}_{c} )}^{2}} \leq r\end{matrix} \qquad [ Mathematical formula 1 ]$$

Here, (x_{b}, y_{b}, z_{b}) is three-dimensional coordinates of a voxel and (x_{c}, y_{c}, z_{c}) is three-dimensional coordinates in the virtual space, which correspond to the position of the imaging apparatus 103′. Further, r is the pixel value of the depth map in a case where the voxel is projected onto the depth map toward the imaging apparatus 103′ and “is_included” represents the results of the above-described determination. Here, in a case where “is_included” is 1, it is indicated that the voxel is included in the generation space after deletion and in a case where “is_included” is 0, it is indicated that the voxel is not included in the generation space after deletion. The unnecessary area deletion unit 1714 deletes the voxel whose “is_included” is 0 from the voxel group in the generation space. As described above, by deleting the voxels in the unnecessary space from the voxel group in the generation space by using the distance information, the unnecessary area mask image data, and the image capturing parameters, it is possible to generate the generation space after deletion having a complicated shape in the surface of which there is a concave portion, in addition to the generation space after deletion having the shape of a hemisphere.

After S1803, the second image processing apparatus 100 performs the processing at S504 to S508. After S508, the second image processing apparatus 100 terminates the processing of the flowchart shown in FIG. 18. In a case where the imaging apparatus 103 captures a moving image, for example, the second image processing apparatus 100 returns to S504 after the processing of the flowchart is terminated and repeatedly performs the processing at S504 to S508 until instructions to terminate the generation of a virtual viewpoint image are input from the operation unit 306.

According to the second image processing apparatus 100 configured as above, it is possible to reduce the amount of calculation in a case where three-dimensional shape data is generated. Particularly, according to the second image processing apparatus 100, by deleting the voxels in the unnecessary space from the voxel group in the generation space by using the distance information, the image capturing parameters, and the unnecessary area mask image, it is possible to generate the generation space after deletion having a complicated shape. As a result, according to the second image processing apparatus 100, it is possible to generate three-dimensional shape data of a higher accuracy while reducing the amount of calculation in a case where the three-dimensional shape data is generated.

### Other Embodiments

In each embodiment described above, the aspect is explained in which the first image processing apparatus 110 and the second image processing apparatus 100 are configured by apparatuses different from each other, but the aspect is not limited to this. For example, the image processing system 1 may comprise an image processing apparatus having the function of the first image processing apparatus 110 and the function of the second image processing apparatus 100. Further, in each embodiment described above, the aspect is explained in which the imaging apparatus 103 and the first image processing apparatus 110 are configured by apparatuses different from each other, but the aspect is not limited to this. For example, the imaging apparatus 103 may comprise the function of the first image processing apparatus 110. Further, in each embodiment described above, the aspect is explained in which the second image processing apparatus 100 generates a virtual viewpoint image, but the aspect is not limited to this. For example, it may also be possible for another image processing apparatus different from the second image processing apparatus 100 to generate a virtual viewpoint image. In this case, the second image processing apparatus 100 may not have the function to generate a virtual viewpoint image.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to reduce the amount of calculation in a case where three-dimensional shape data is generated.

This application claims the benefit of Japanese Patent Application No. 2022-184759, filed Nov. 18, 2022 which is hereby incorporated by reference wherein in its entirety.

What is claimed is:

1. An image processing apparatus generating three-dimensional shape data corresponding to a foreground object for which synchronous image capturing is performed by a plurality of imaging apparatuses, the image processing apparatus comprising:
one or more hardware processors; and
one or more memories storing one or more programs configured to be executed by the one or more hardware processors, the one or more programs including instructions for:
identifying an unnecessary space, which is a space unnecessary in a case where three-dimensional shape data is generated, from a first generation space in a virtual space corresponding to an image capturing-target space;
generating information indicating a second generation space after the unnecessary space is deleted by deleting the identified unnecessary space from the first generation space; and
generating the three-dimensional shape data corresponding to the foreground object in the second generation space based on image capturing parameters of an imaging apparatus, which is at least part of the plurality of imaging apparatuses, a captured image obtained by image capturing by the part of the imaging apparatuses, and information indicating the second generation space.

2. The image processing apparatus according to claim 1, wherein
the unnecessary space is identified by using image capturing parameters of an imaging apparatus belonging to a first imaging apparatus group, which is at least part of the plurality of imaging apparatuses, and a mask image for masking an image area in which an actually existing space corresponding to the unnecessary space is captured from a captured image obtained by image capturing by an imaging apparatus belonging to the first imaging apparatus group and
the three-dimensional shape data is generated based on image capturing parameters of an imaging apparatus belonging to a second imaging apparatus group different from the first imaging apparatus group, which is at least part of the plurality of imaging apparatuses, and a captured image obtained by image capturing by an imaging apparatus belonging to the second imaging apparatus group.

3. The image processing apparatus according to claim 2, wherein
an area in the first generation space is identified as the unnecessary space, which is shielded by a mask area in the mask image arranged in the virtual space in a case where the mask image is arranged in the virtual space by using image capturing parameters of an imaging apparatus belonging to the first imaging apparatus group and the virtual space is captured based on image capturing parameters of an imaging apparatus belonging to the first imaging apparatus group from a position in the virtual space, which corresponds to an imaging apparatus belonging to the first imaging apparatus group.

4. The image processing apparatus according to claim 2, wherein
the three-dimensional shape data is generated based on image capturing parameters of an imaging apparatus belonging to the first imaging apparatus group and a captured image obtained by image capturing by an imaging apparatus belonging to the first imaging apparatus group, in addition to image capturing parameters of an imaging apparatus belonging to the second imaging apparatus group and a captured image obtained by image capturing by an imaging apparatus belonging to the second imaging apparatus group.

5. The image processing apparatus according to claim 1, wherein
the unnecessary space is identified by using image capturing parameters of an imaging apparatus belonging to a first imaging apparatus group, which is at least part of the plurality of imaging apparatuses, and a silhouette image indicating a foreground area, which is an image area in which the foreground object is captured, in a captured image obtained by image capturing by an imaging apparatus belonging to the first imaging apparatus group and
the three-dimensional shape data is generated based on image capturing parameters of an imaging apparatus belonging to a second imaging apparatus group different from the first imaging apparatus group, which is at least part of the plurality of imaging apparatuses, and a captured image obtained by image capturing by an imaging apparatus belonging to the second imaging apparatus group.

6. The image processing apparatus according to claim 5, wherein
an area in the first generation space is identified as the unnecessary space, which is shielded by a background area, which is an area indicating a background in the silhouette image arranged in the virtual space, in a case where the silhouette image is arranged in the virtual space by using image capturing parameters of an imaging apparatus belonging to the first imaging apparatus group and the virtual space is captured based on image capturing parameters of an imaging apparatus belonging to the first imaging apparatus group from a position in the virtual space, which corresponds to an imaging apparatus belonging to the first imaging apparatus group.

7. The image processing apparatus according to claim 1, wherein
the one or more programs further include an instruction for:
obtaining distance information indicating a distance between each of a plurality of points on a boundary surface between an actually existing space corresponding to the second generation space and an actually existing space corresponding to the unnecessary space, and an imaging apparatus belonging to a first imaging apparatus group, which is at least part of the plurality of imaging apparatuses, and wherein
the unnecessary space is identified by using the distance information, and
the three-dimensional shape data is generated based on image capturing parameters of an imaging apparatus belonging to a second imaging apparatus group different from the first imaging apparatus group, which is at least part of the plurality of imaging apparatuses, and a captured image obtained by image capturing by an imaging apparatus belonging to the second imaging apparatus group.

8. The image processing apparatus according to claim 1, wherein
the unnecessary space is identified by using a mask image capable of masking an actually existing space corresponding to the unnecessary space in a captured image obtained in a case where it is assumed that an imaginary imaging apparatus is arranged at a predetermined position and the imaginary imaging apparatus captures the image capturing-target space based on predetermined image capturing parameters, and the predetermined image capturing parameters.

9. The image processing apparatus according to claim 8, wherein
an area in the first generation space is identified as the unnecessary space, which is shielded by a mask area in the mask image arranged in the virtual space in a case where the mask image is arranged in the virtual space by using the predetermined image capturing parameters and the virtual space is captured based on the predetermined image capturing parameters from a position in the virtual space, which corresponds to the predetermined position.

10. The image processing apparatus according to claim 8, wherein
the one or more programs further include an instruction for:
obtaining distance information indicating a distance between each of a plurality of points on a boundary surface between an actually existing space corresponding to the second generation space and an actually existing space corresponding to the unnecessary space, and the predetermined position, and wherein
the unnecessary space is identified by using the distance information, in addition to the mask image and the predetermined image capturing parameters.

11. The image processing apparatus according to claim 8, wherein
the three-dimensional shape data is generated by a visual hull method by using a silhouette image indicating a foreground area, which is an image area in which the foreground object is captured in part of a captured image, the silhouette image being generated based on a captured image obtained by image capturing by an imaging apparatus, which is at least part of the plurality of imaging apparatuses.

12. The image processing apparatus according to claim 1, wherein
the one or more programs further include an instruction for:
generating a virtual viewpoint image based on the generated three-dimensional shape data, data of a captured image obtained by image capturing by an imaging apparatus, which is at least part of the plurality of imaging apparatuses, and virtual viewpoint information including information indicting a position of a virtual viewpoint and a direction of a line-of-sight from the virtual viewpoint.

13. An image processing method of generating three-dimensional shape data corresponding to a foreground object for which synchronous image capturing is performed by a plurality of imaging apparatuses, the image processing method comprising the steps of:
identifying an unnecessary space, which is a space unnecessary in a case where three-dimensional shape data is generated, from a first generation space in a virtual space corresponding to an image capturing-target space;
generating information indicating a second generation space after the unnecessary space is deleted by deleting the identified unnecessary space from the first generation space; and
generating the three-dimensional shape data corresponding to the foreground object in the second generation space based on image capturing parameters of an imaging apparatus, which is at least part of the plurality of imaging apparatuses, a captured image obtained by image capturing by the part of the imaging apparatuses, and information indicating the second generation space.

14. A non-transitory computer readable storage medium storing a program for causing a computer to perform a control method of an apparatus generating three-dimensional shape data corresponding to a foreground object for which synchronous image capturing is performed by a plurality of imaging apparatuses, the control method comprising the steps of:
identifying an unnecessary space, which is a space unnecessary in a case where three-dimensional shape data is generated, from a first generation space in a virtual space corresponding to an image capturing-target space;
generating information indicating a second generation space after the unnecessary space is deleted by deleting the identified unnecessary space from the first generation space; and
generating the three-dimensional shape data corresponding to the foreground object in the second generation space based on image capturing parameters of an imaging apparatus, which is at least part of the plurality of imaging apparatuses, a captured image obtained by image capturing by the part of the imaging apparatuses, and information indicating the second generation space.
